(19) United States
(12) Patent Application Publication
(10) Pub. No.: US 2026/0261491 A1
(43) Pub. Date: Sep. 3, 2026

(54) COMMUNICATION METHOD AND RELATED DEVICE

(71) Applicant: Huawei Technologies Co., Ltd., Shenzhen (CN)

(72) Inventors: Chen Xu, Hangzhou (CN); Gongzheng Zhang, Hangzhou (CN); Jian Wang, Hangzhou (CN); Rong Li, Shanghai (CN)

(21) Appl. No.: 19/664,415

(22) Filed: Apr. 30, 2026

Related U.S. Application Data
(63) Continuation of application No. PCT/CN2024/114187, filed on Aug. 23, 2024.

(30) Foreign Application Priority Data
Nov. 3, 2023 (CN) 202311462850.9

(51) Int. Cl. H04L 41/16; H04W 72/0446; H04W 72/1263

(52) U.S. Cl. CPC H04L 41/16; H04W 72/0446; H04W 72/1263

(57) ABSTRACT

A communication method and a related device are provided, where first data received by a first communication apparatus is data obtained through first processing and second data sent by the first communication apparatus is gradient data obtained based on data obtained by performing second processing based on the first data and label data, or second data is data obtained through first processing and first data is gradient data obtained based on data obtained by performing second processing based on the second data and label data. In addition, the first processing includes AI processing, and/or the second processing includes AI processing.

### CROSS-REFERENCE TO RELATED APPLICATIONS

This application is a continuation of International Application No. PCT/CN2024/114187, filed on Aug. 23, 2024, which claims priority to Chinese Patent Application No. 202311462850.9, filed on Nov. 3, 2023. The disclosures of the aforementioned applications are hereby incorporated by reference in their entireties.

### TECHNICAL FIELD

This application relates to the communication field, and in particular, to a communication method and a related device.

### BACKGROUND

Wireless communication may be transmission communication performed between two or more communication nodes without propagation through a conductor or a cable. The communication nodes usually include a network device and a terminal device.

Currently, in a wireless communication system, a communication node usually has a signal receiving and sending capability and a computing capability. For example, in a network device with a computing capability, its computing capability mainly provides computational power support for a signal receiving and sending capability (for example, performing sending processing and receiving processing on a signal), to implement communication between the network device and other communication nodes.

However, in a communication network, in addition to providing computational power support for the foregoing communication task based on the computing capability of the communication node, the communication node may further have a surplus computing capability. Therefore, how to use these computing capabilities is an urgent technical problem to be resolved.

### SUMMARY

This application provides a communication method and a related device, so that computational power of a communication node can be applied to artificial intelligence (AI) processing of a neural network, and flexibility of neural network deployment can be improved.

A first aspect of this application provides a communication method. The method is performed by a first communication apparatus. The first communication apparatus may be a communication device (for example, a terminal device), or the first communication apparatus may be a part of components (for example, a processor, a chip, or a chip system) in the communication device, or the first communication apparatus may be a logical module or software that can implement all or a part of functions of the communication device. In the method, a first communication apparatus receives configuration information. The configuration information is used to configure a transmission resource of first information, and the first information is used to schedule transmission of first data. The first communication apparatus receives the first data based on the first information. The first communication apparatus sends second information. The second information is used to schedule transmission of second data. The first communication apparatus sends the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

Based on the foregoing technical solution, the first data is the data obtained through the first processing and the second data is the gradient data obtained based on the data obtained by performing the second processing based on the first data and the label data, or the second data is the data obtained through the first processing and the first data is the gradient data obtained based on the data obtained by performing the second processing based on the second data and the label data. In addition, the first processing includes AI processing, and/or the second processing includes AI processing. In other words, the second data is gradient data corresponding to data obtained by performing AI processing based on the first data, or the first data is gradient data corresponding to data obtained by performing AI processing based on the second data. Therefore, when a communication apparatus in a communication system serves as an AI participating node, computational power of the communication apparatus can be applied to AI processing, and flexibility of AI deployment can be improved.

In addition, the configuration information received by the first communication apparatus is used to configure the transmission resource of the first information, and the first information is used to schedule transmission of the first data. Correspondingly, the first communication apparatus can receive the first data based on the first information. In addition, after the first communication apparatus sends the second information used to schedule transmission of the second data, the first communication apparatus can send the second data based on the second information. In other words, when one or both of the first data and the second data are data associated with AI processing, the first communication apparatus can implement, through scheduling based on the first information and the second information, transmission of the data associated with the AI processing. Therefore, scheduling, based on the first information and the second information, the data associated with the AI processing can improve a transmission success rate of the data associated with the AI processing.

In this application, because the first processing includes AI processing, and/or the second processing includes AI processing, the gradient data and/or a result of a loss function may be obtained based on the data obtained through the first processing or the second processing and the label data. Correspondingly, in this application, the gradient data may be replaced with the result of the loss function, the gradient data and the result of the loss function, or the like.

In this application, terms such as AI, neural network, AI neural network, machine learning, AI processing, and AI neural network processing may be replaced with each other.

In this application, related data (for example, the first data and the second data) may be replaced with information, a signal, or the like.

It should be understood that the second data may be data obtained based on the first data. For example, when the first data is the data obtained through the first processing and the second data is the gradient data obtained based on the data obtained by performing the second processing based on the first data and the label data, the first data is data sent by a sender (for example, a second communication apparatus) of the first data after the first processing is performed, and the second data is data obtained by the first communication apparatus by performing the second processing based on the received first data. In this case, the first data may be referred to as forward data, and the second data may be referred to as backward data (for example, a backward gradient, or the result of the loss function).

It should be understood that the first data may be data obtained based on the second data. For example, when the second data is data obtained through the first processing and the first data is the gradient data obtained based on the data obtained by performing the second processing based on the second data and the label data, the second data is data sent by the first communication apparatus after the first processing is performed, and the first data is data obtained by a sender (for example, a second communication apparatus) of the first data by performing the second processing based on the received second data. In this case, the second data may be referred to as forward data, and the first data may be referred to as backward data (for example, a backward gradient, or the result of the loss function).

Optionally, in the foregoing process, if the first processing includes AI processing, the AI processing in the first processing may be referred to as encoding neural network processing, AI encoder processing, AI encoding neural network processing, or the like. Correspondingly, if the second processing includes AI processing, the AI processing in the second processing may be referred to as decoding neural network processing, AI decoder processing, AI decoding neural network processing, or the like.

It should be noted that, in a wireless communication system, one or both of the first information used to schedule the first data and the second information used to schedule the second data may be a message/signaling/information of a radio resource control (RRC) layer, a medium access control (MAC) layer, a physical (PHY) layer, or another protocol layer.

In addition, compared with an implementation in which the communication apparatus performs physical layer processing on received application layer data and then dequantizes a physical layer processing result to obtain application layer scheduling signaling (the scheduling signaling is used to schedule transmission of data associated with AI processing), when one or both of the first information used to schedule the first data and/or the second information used to schedule the second data are physical layer signaling, transmission of data associated with AI processing can be quickly scheduled by using the physical layer signaling, thereby reducing a processing delay.

For example, the first information used to schedule the first data is from the second communication apparatus. The second communication apparatus may be a network device. Correspondingly, the first information may be downlink control information (DCI) sent by the network device to the terminal device, and the second information may be uplink control information (UCI) sent by the terminal device to the network device. Alternatively, the second communication apparatus may be another terminal device different from the first communication apparatus. Correspondingly, the first information and the second information may be sidelink control information (SCI) exchanged between different terminal devices.

In a possible implementation of the first aspect, the transmission resource of the first information includes a time domain resource carrying the first information, and a time interval between the time domain resource carrying the first information and a time domain resource carrying the second information is preconfigured.

Based on the foregoing technical solution, the time interval between the time domain resource carrying the first information and the time domain resource carrying the second information is preconfigured. In this manner, after the first communication apparatus receives the first information, the first communication apparatus can determine, based on the preconfigured time interval and the time domain resource carrying the first information, the time domain resource carrying the second information, and send the second information on the time domain resource carrying the second information. In addition, the second communication apparatus can receive the second information based on the preconfigured time interval, to reduce resource configuration overheads of the second information.

In a possible implementation of the first aspect, the first data is the data obtained through the first processing and the second data is the gradient data obtained based on the data obtained by performing the second processing based on the first data and the label data; the first processing satisfies any one of the following: the first processing is triggered based on the second information, and the first information is triggered based on the first processing; and the second processing satisfies any one of the following: the second processing is triggered based on the first information, the second information is triggered based on the second processing, the second processing is triggered based on the first data, and the second processing is triggered based on the first information and the first data.

In a possible implementation of the first aspect, the second data is the data obtained through the first processing and the first data is the gradient data obtained based on the data obtained by performing the second processing based on the second data and the label data; the first processing satisfies any one of the following: the first processing is triggered based on the first information, and the second information is triggered based on the first processing; and the second processing satisfies any one of the following: the second processing is triggered based on the second information, the first information is triggered based on the second processing, the second processing is triggered based on the second data, and the second processing is triggered based on the second information and the second data.

Based on the foregoing technical solution, because the first processing includes AI processing, and/or the second processing includes AI processing, scheduling of AI data can be triggered by AI processing in the foregoing implementation, or AI processing can be triggered by scheduling of AI data in the foregoing implementation. Therefore, AI processing and scheduling of AI data can be mutually triggered, thereby reducing interaction of an AI processing triggering indication or an AI data scheduling triggering indication, and reducing a processing delay and overheads. Alternatively, in the foregoing implementation, AI processing can be triggered by transmission of AI data. Therefore, AI processing and transmission of AI data can be mutually triggered, thereby reducing interaction of an AI processing trigger indication, reducing a processing delay, and reducing overheads.

In a possible implementation of the first aspect, the configuration information includes a first configuration and a second configuration, the first configuration is used to configure a search space of the first information, and the second configuration is used to configure a retransmission timer of the second information; and a time length of a periodicity corresponding to the search space is less than or equal to a time length of the retransmission timer.

Based on the foregoing technical solution, the configuration information used to configure the transmission resource of the first information may include the first configuration and the second configuration. The first configuration is used to configure a search space of the first information, and the second configuration is used to configure the retransmission timer of the second information. In this manner, the first communication apparatus can implement receiving of the first information and retransmission of the second information based on the configuration information, thereby improving a transmission success rate of the first information and a transmission success rate of the second information.

In addition, because the first information and AI processing may be mutually triggered, that is, the first information may be executed aperiodically, in an implementation in which the time length of the periodicity corresponding to the search space is less than or equal to the time length of the retransmission timer, the first communication apparatus can detect the first information in a periodicity with a short time length, so that the first communication apparatus can implement receiving of data obtained through AI processing in a timely manner or implement triggering of AI processing in a timely manner. In addition, a timer with a long time length can reduce overheads of retransmitting the second information by the first communication apparatus.

In a possible implementation of the first aspect, the method further includes: The first communication apparatus sends first indication information. The first indication information indicates whether the first information is correctly received.

In this application, whether being correctly received may be replaced with a description of another term, including but not limited to: whether being incorrectly received, whether being correctly parsed, or whether being incorrectly parsed.

Based on the foregoing technical solution, the first communication apparatus may further send the first indication information, so that the second communication apparatus can determine, based on the first indication information, whether the first communication apparatus correctly receives the first information. Subsequently, the second communication apparatus may determine, based on the first indication information, whether to retransmit the first information and/or the first data scheduled based on the first information.

In addition, the first information is used to schedule the first data. Usually, a receiver of the first information and the first data feeds back, for the first data, whether the first data is correctly received, and the receiver does not feed back, for the first information, whether the first information is correctly received. However, in the foregoing technical solution, if the first information may be used to trigger AI processing (for example, the first processing and/or the second processing), the first indication information indicates whether the first information is correctly received, so that a receiver of the first indication information determines whether the first communication apparatus triggers corresponding AI processing based on the first information.

In a possible implementation of the first aspect, the first indication information indicates that the first information is correctly received, and when the first data is the data obtained through the first processing and the second data is the gradient data obtained based on the data obtained by performing the second processing based on the first data and the label data, the first indication information is further used to trigger the first processing; and the first indication information indicates that the first information is correctly received, and when the second data is the data obtained through the first processing and the first data is the gradient data obtained based on the data obtained by performing the second processing based on the second data and the label data, the first indication information is further used to trigger the second processing.

Based on the foregoing technical solution, when the first indication information indicates that the first information is correctly received, the first indication information may be further used to trigger AI processing (for example, the first processing and/or the second processing). Therefore, the first indication information indicates that the first information is correctly received, so that the receiver of the first indication information can trigger corresponding AI processing based on the first indication information.

In a possible implementation of the first aspect, the first indication information further indicates whether to perform processing based on the first data.

Optionally, when the first data is the data obtained through the first processing and the second data is the gradient data obtained based on the data obtained by performing the second processing based on the first data and the label data, the first data may be data obtained based on the second data. Therefore, that the first indication information may further indicate whether to perform processing based on the first data may be understood that the first indication information may further indicate whether the first communication apparatus performs further processing based on the data obtained by performing the second processing based on the first data and the label data, to obtain the gradient data.

Optionally, when the second data is the data obtained through the first processing and the first data is the gradient data obtained based on the data obtained by performing the second processing based on the second data and the label data, the second data may be data obtained based on the first data. Therefore, that the first indication information may further indicate whether to perform processing based on the first data may be understood that the first indication information may further indicate whether the first communication apparatus performs gradient updating processing based on the first data (namely, the gradient data).

Based on the foregoing technical solution, in addition to indicating whether the first information is correctly received, the first indication information further indicates whether to perform processing based on the first data. In this manner, the first indication information can be reused to implement more indications, to reduce overheads.

In a possible implementation of the first aspect, after the first communication apparatus sends the second information, the method further includes: The first communication apparatus receives second indication information. The second indication information indicates whether the second information is correctly received.

Based on the foregoing technical solution, after the first communication apparatus sends the second information, the first communication apparatus may further receive the second indication information, so that the first communication apparatus determines, based on the second indication information, whether the second communication apparatus correctly receives the second information. Subsequently, the first communication apparatus may determine, based on the second indication information, whether to retransmit the second information and/or the second data scheduled based on the second information.

In a possible implementation of the first aspect, the second indication information indicates that the second information is correctly received, and when the first data is the data obtained through the first processing and the second data is the gradient data obtained based on the data obtained by performing the second processing based on the first data and the label data, the second indication information is further used to trigger the second processing; and the second indication information indicates that the second information is correctly received, and when the second data is the data obtained through the first processing and the first data is the gradient data obtained based on the data obtained by performing the second processing based on the second data and the label data, the second indication information is used to trigger the first processing.

Based on the foregoing technical solution, when the second indication information indicates that the second information is correctly received, the second indication information may be further used to trigger AI processing (for example, the first processing and/or the second processing). Therefore, the second indication information indicates that the second information is correctly received, so that a receiver of the second indication information can trigger corresponding AI processing based on the second indication information.

In a possible implementation of the first aspect, the second indication information further indicates whether to perform processing based on the second data.

Optionally, when the first data is the data obtained through the first processing and the second data is the gradient data obtained based on the data obtained by performing the second processing based on the first data and the label data, the first data may be data obtained based on the second data. Therefore, that the second indication information may further indicate whether to perform processing based on the second data may be understood that the second indication information may further indicate whether the second communication apparatus performs gradient updating processing based on the second data (namely, the gradient data).

Optionally, when the second data is the data obtained through the first processing and the first data is the gradient data obtained based on the data obtained by performing the second processing based on the second data and the label data, the second data may be data obtained based on the first data. Therefore, that the second indication information may further indicate whether to perform processing based on the second data may be understood that the second indication information may further indicate whether the second communication apparatus performs further processing based on the data obtained by performing the second processing based on the second data and the label data, to obtain the gradient data.

Based on the foregoing technical solution, in addition to indicating whether the second information is correctly received, the second indication information further indicates whether to perform processing based on the second data. In this manner, the second indication information can be reused to implement more indications, to reduce overheads.

In a possible implementation of the first aspect, the second information further indicates at least one of the following items: a data type of the second data, and whether to send gradient information determined based on the second data.

Based on the foregoing technical solution, the second information further indicates at least one of the foregoing items, so that a receiver (namely, the second communication apparatus) of the second information can obtain, based on the second information, other information associated with the second data, and assist in subsequent processing of the second data based on the other information.

In a possible implementation of the first aspect, the first information further indicates at least one of the following items: a data type of the first data, and whether to send gradient information determined based on the first data.

Based on the foregoing technical solution, the first information further indicates at least one of the foregoing items, so that a receiver (namely, the first communication apparatus) of the first information can obtain, based on the first information, other information associated with the first data, and assist in subsequent processing of the first data based on the other information.

In a possible implementation of the first aspect, after the first communication apparatus receives the first information, the method further includes: When the first information is incorrectly parsed, the first communication apparatus determines not to receive the first data.

Optionally, after the first communication apparatus receives the first information, the method further includes: When the first information is incorrectly parsed, the first communication apparatus does not expect to receive the first data.

Based on the foregoing technical solution, when the first information is incorrectly parsed, the first communication apparatus may determine not to receive the first data, to avoid receiving incorrect data.

In a possible implementation of the first aspect, the method further includes: The first communication apparatus sends capability information of the first communication apparatus. The capability information of the first communication apparatus is used to determine the configuration information. The AI capability information of the first communication apparatus includes at least one of the following items: processing delay information of the first communication apparatus for forward data in an AI network structure to which the first data belongs, processing delay information of the first communication apparatus for backward data in the AI network structure to which the first data belongs, a batch size of the first data, load information of a processing resource of the first communication apparatus, and computational power resource information of the first communication apparatus.

Based on the foregoing technical solution, the first communication apparatus may send the capability information of the first communication apparatus, so that the second communication apparatus determines, based on the capability information, configuration information adapted to the capability information, to improve a success rate of receiving the first information by the first communication apparatus based on the configuration information.

Optionally, the configuration information includes at least one of the following items: a periodicity of the first information, window duration of detecting the first information, and a position of a transmission symbol of the first information in a slot. For example, the configuration information may include the first configuration, the at least one item may be included in the first configuration, and the first configuration is used to configure the search space for the first information.

In a possible implementation of the first aspect, the method further includes: The first communication apparatus receives third information. The third information indicates at least one of the following items: information about the AI network structure to which the first data belongs, a hyperparameter of the AI network structure, and dataset information of an AI task to which the first data belongs.

Based on the foregoing technical solution, the first communication apparatus may further receive the third information indicating at least one of the foregoing items, so that the first communication apparatus can perform a subsequent AI processing process based on the third information.

A second aspect of this application provides a communication method. The method is performed by a second communication apparatus. The second communication apparatus may be a communication device (for example, a terminal device or a network device), or the second communication apparatus may be a part of components (for example, a processor, a chip, or a chip system) in the communication device, or the second communication apparatus may be a logical module or software that can implement all or a part of functions of the communication device. In the method, the second communication apparatus sends configuration information. The configuration information is used to configure a transmission resource of first information, and the first information is used to schedule transmission of first data. The second communication apparatus sends the first data based on the first information. The second communication apparatus receives second information. The second information is used to schedule transmission of second data. The second communication apparatus receives the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

Based on the foregoing technical solution, the first data is the data obtained through the first processing and the second data is the gradient data obtained based on the data obtained by performing the second processing based on the first data and the label data, or the second data is the data obtained through the first processing and the first data is the gradient data obtained based on the data obtained by performing the second processing based on the second data and the label data. In addition, the first processing includes AI processing, and/or the second processing includes AI processing. In other words, the second data is gradient data corresponding to data obtained by performing AI processing based on the first data, or the first data is gradient data corresponding to data obtained by performing AI processing based on the second data. Therefore, when a communication apparatus in a communication system serves as an AI participating node, computational power of the communication apparatus can be applied to AI processing, and flexibility of AI deployment can be improved.

In addition, the configuration information sent by the second communication apparatus is used to configure the transmission resource of the first information, and the first information is used to schedule transmission of first data. Correspondingly, the second communication apparatus can send the first data based on the first information. In addition, after the second communication apparatus receives the second information used to schedule transmission of the second data, the second communication apparatus can receive the second data based on the second information. In other words, when one or both of the first data and the second data are data associated with AI processing, the second communication apparatus can implement, through scheduling based on the first information and the second information, transmission of the data associated with the AI processing. Therefore, scheduling, based on the first information and the second information, the data associated with the AI processing can improve a transmission success rate of the data associated with the AI processing.

In a possible implementation of the second aspect, the transmission resource of the first information includes a time domain resource carrying the first information, and a time interval between the time domain resource carrying the first information and a time domain resource carrying the second information is preconfigured.

Based on the foregoing technical solution, the time interval between the time domain resource carrying the first information and the time domain resource carrying the second information is preconfigured. In this manner, after the second communication apparatus sends the first information, the first communication apparatus can determine, based on the preconfigured time interval and the time domain resource carrying the first information, the time domain resource carrying the second information, and send the second information on the time domain resource carrying the second information. In addition, the second communication apparatus can receive the second information based on the preconfigured time interval, to reduce resource configuration overheads of the second information.

In a possible implementation of the second aspect, the first data is the data obtained through the first processing and the second data is the gradient data obtained based on the data obtained by performing the second processing based on the first data and the label data; the first processing satisfies any one of the following: the first processing is triggered based on the second information, and the first information is triggered based on the first processing; and the second processing satisfies any one of the following: the second processing is triggered based on the first information, the second information is triggered based on the second processing, the second processing is triggered based on the first data, and the second processing is triggered based on the first information and the first data.

In a possible implementation of the second aspect, the second data is the data obtained through the first processing and the first data is the gradient data obtained based on the data obtained by performing the second processing based on the second data and the label data; the first processing satisfies any one of the following: the first processing is triggered based on the first information, and the second information is triggered based on the first processing; and the second processing satisfies any one of the following: the second processing is triggered based on the second information, the first information is triggered based on the second processing, the second processing is triggered based on the second data, and the second processing is triggered based on the second information and the second data.

Based on the foregoing technical solution, because the first processing includes AI processing, and/or the second processing includes AI processing, scheduling of AI data can be triggered by AI processing in the foregoing implementation, or AI processing can be triggered by scheduling of AI data in the foregoing implementation. Therefore, AI processing and scheduling of AI data can be mutually triggered, thereby reducing interaction of an AI processing triggering indication or an AI data scheduling triggering indication, and reducing a processing delay and overheads. Alternatively, in the foregoing implementation, AI processing can be triggered by transmission of AI data. Therefore, AI processing and transmission of AI data can be mutually triggered, thereby reducing interaction of an AI processing trigger indication, reducing a processing delay, and reducing overheads.

In a possible implementation of the second aspect, the configuration information includes a first configuration and a second configuration, the first configuration is used to configure a search space of the first information, and the second configuration is used to configure a retransmission timer of the second information; and a time length of a periodicity corresponding to the search space is less than or equal to a time length of the retransmission timer.

Based on the foregoing technical solution, the configuration information used to configure the transmission resource of the first information may include the first configuration and the second configuration. The first configuration is used to configure the search space of the first information, and the second configuration is used to configure a retransmission timer of the second information. In this manner, the first communication apparatus can implement receiving of the first information and retransmission of the second information based on the configuration information, thereby improving a transmission success rate of the first information and a transmission success rate of the second information.

In addition, because the first information and AI processing may be mutually triggered, that is, the first information may be executed aperiodically, in an implementation in which the time length of the periodicity corresponding to the search space is less than or equal to the time length of the retransmission timer, the first communication apparatus can detect the first information in a periodicity with a short time length, so that the first communication apparatus can implement receiving of data obtained through AI processing in a timely manner or implement triggering of AI processing in a timely manner. In addition, a timer with a long time length can reduce overheads of retransmitting the second information by the first communication apparatus.

In a possible implementation of the second aspect, the method further includes: The second communication apparatus receives first indication information. The first indication information indicates whether the first information is correctly received.

Based on the foregoing technical solution, the second communication apparatus may further receive the first indication information, so that the second communication apparatus can determine, based on the first indication information, whether the first communication apparatus correctly receives the first information. Subsequently, the second communication apparatus may determine, based on the first indication information, whether to retransmit the first information and/or the first data scheduled based on the first information.

In addition, the first information is used to schedule the first data. Usually, a receiver of the first information and the first data feeds back, for the first data, whether the first data is correctly received, and the receiver does not feed back, for the first information, whether the first information is correctly received. However, in the foregoing technical solution, if the first information may be used to trigger AI processing (for example, the first processing and/or the second processing), the first indication information indicates whether the first information is correctly received, so that a receiver of the first indication information determines whether the first communication apparatus triggers corresponding AI processing based on the first information.

In a possible implementation of the second aspect, the first indication information indicates that the first information is correctly received, and when the first data is the data obtained through the first processing and the second data is the gradient data obtained based on the data obtained by performing the second processing based on the first data and the label data, the first indication information is further used to trigger the first processing; and the first indication information indicates that the first information is correctly received, and when the second data is the data obtained through the first processing and the first data is the gradient data obtained based on the data obtained by performing the second processing based on the second data and the label data, the first indication information is further used to trigger the second processing.

Based on the foregoing technical solution, when the first indication information indicates that the first information is correctly received, the first indication information may be further used to trigger AI processing (for example, the first processing and/or the second processing). Therefore, the first indication information indicates that the first information is correctly received, so that the receiver of the first indication information can trigger corresponding AI processing based on the first indication information.

In a possible implementation of the second aspect, the first indication information further indicates whether to perform processing based on the first data.

Optionally, when the first data is the data obtained through the first processing and the second data is the gradient data obtained based on the data obtained by performing the second processing based on the first data and the label data, the first data may be data obtained based on the second data. Therefore, that the first indication information may further indicate whether to perform processing based on the first data may be understood that the first indication information may further indicate whether the first communication apparatus performs further processing based on the data obtained by performing the second processing based on the first data and the label data, to obtain the gradient data.

Optionally, when the second data is the data obtained through the first processing and the first data is the gradient data obtained based on the data obtained by performing the second processing based on the second data and the label data, the second data may be data obtained based on the first data. Therefore, that the first indication information may further indicate whether to perform processing based on the first data may be understood that the first indication information may further indicate whether the first communication apparatus performs gradient updating processing based on the first data (namely, the gradient data).

Based on the foregoing technical solution, in addition to indicating whether the first information is correctly received, the first indication information further indicates whether to perform processing based on the first data. In this manner, the first indication information can be reused to implement more indications, to reduce overheads.

In a possible implementation of the second aspect, after the second communication apparatus receives the second information, the method further includes: The second communication apparatus sends second indication information. The second indication information indicates whether the second information is correctly received.

Based on the foregoing technical solution, after the second communication apparatus receives the second information, the second communication apparatus may further send the second indication information, so that the first communication apparatus determines, based on the second indication information, whether the second communication apparatus correctly receives the second information. Subsequently, the first communication apparatus may determine, based on the second indication information, whether to retransmit the second information and/or the second data scheduled based on the second information.

In a possible implementation of the second aspect, the second indication information indicates that the second information is correctly received, and when the first data is the data obtained through the first processing and the second data is the gradient data obtained based on the data obtained by performing the second processing based on the first data and the label data, the second indication information is further used to trigger the second processing; and the second indication information indicates that the second information is correctly received, and when the second data is the data obtained through the first processing and the first data is the gradient data obtained based on the data obtained by performing the second processing based on the second data and the label data, the second indication information is used to trigger the first processing.

Based on the foregoing technical solution, when the second indication information indicates that the second information is correctly received, the second indication information may be further used to trigger AI processing (for example, the first processing and/or the second processing). Therefore, the second indication information indicates that the second information is correctly received, so that a receiver of the second indication information can trigger corresponding AI processing based on the second indication information.

In a possible implementation of the second aspect, the second indication information further indicates whether to perform processing based on the second data.

Optionally, when the first data is the data obtained through the first processing and the second data is the gradient data obtained based on the data obtained by performing the second processing based on the first data and the label data, the first data may be data obtained based on the second data. Therefore, that the second indication information may further indicate whether to perform processing based on the second data may be understood that the second indication information may further indicate whether the second communication apparatus performs gradient updating processing based on the second data (namely, the gradient data).

Optionally, when the second data is the data obtained through the first processing and the first data is the gradient data obtained based on the data obtained by performing the second processing based on the second data and the label data, the second data may be data obtained based on the first data. Therefore, that the second indication information may further indicate whether to perform processing based on the second data may be understood that the second indication information may further indicate whether the second communication apparatus performs further processing based on the data obtained by performing the second processing based on the second data and the label data, to obtain the gradient data.

Based on the foregoing technical solution, in addition to indicating whether the second information is correctly received, the second indication information further indicates whether to perform processing based on the second data. In this manner, the second indication information can be reused to implement more indications, to reduce overheads.

In a possible implementation of the second aspect, the second information further indicates at least one of the following items: a data type of the second data, and whether to send gradient information determined based on the second data.

Based on the foregoing technical solution, the second information further indicates at least one of the foregoing items, so that the second communication apparatus can obtain, based on the second information, other information associated with the second data, and assist in subsequent processing of the second data based on the other information.

In a possible implementation of the second aspect, the first information further indicates at least one of the following items: a data type of the first data, and whether to send gradient information determined based on the first data.

Based on the foregoing technical solution, the first information further indicates at least one of the foregoing items, so that a receiver (namely, the first communication apparatus) of the first information can obtain, based on the first information, other information associated with the first data, and assist in subsequent processing of the first data based on the other information.

In a possible implementation of the second aspect, the method further includes: The second communication apparatus receives capability information of the first communication apparatus. The capability information of the first communication apparatus is used to determine the configuration information. The AI capability information of the first communication apparatus includes at least one of the following items: processing delay information of the first communication apparatus for forward data in an AI network structure to which the first data belongs, processing delay information of the first communication apparatus for backward data in the AI network structure to which the first data belongs, a batch size of the first data, load information of a processing resource of the first communication apparatus, and computational power resource information of the first communication apparatus.

Based on the foregoing technical solution, the second communication apparatus may receive the capability information of the first communication apparatus, so that the second communication apparatus determines, based on the capability information, configuration information adapted to the capability information, and the first communication apparatus can receive a success rate of the first information based on the configuration information.

Optionally, the configuration information includes at least one of the following items: a periodicity of the first information, window duration of detecting the first information, and a position of a transmission symbol of the first information in a slot.

In a possible implementation of the second aspect, the method further includes: The second communication apparatus sends third information. The third information indicates at least one of the following items: information about the AI network structure to which the first data belongs, a hyperparameter of the AI network structure, and dataset information of an AI task to which the first data belongs.

Based on the foregoing technical solution, the second communication apparatus may further send the third information indicating at least one of the foregoing items, so that the first communication apparatus can perform a subsequent AI processing process based on the third information.

A third aspect of this application provides a communication apparatus. The apparatus is a first communication apparatus, and the apparatus includes a transceiver unit and a processing unit. The transceiver unit is configured to receive configuration information. The configuration information is used to configure a transmission resource of first information, and the first information is used to schedule transmission of first data. The processing unit is configured to receive the first data based on the first information. The transceiver unit is further configured to send second information. The second information is used to schedule transmission of second data. The processing unit is further configured to send the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

In the third aspect of this application, a composition module of the communication apparatus may be further configured to: perform the steps performed in the possible implementations of the first aspect, and achieve corresponding technical effects. For details, refer to the first aspect. Details are not described herein again.

A fourth aspect of this application provides a communication apparatus. The apparatus is a second communication apparatus, and the apparatus includes a transceiver unit and a processing unit. The transceiver unit is configured to send configuration information. The configuration information is used to configure a transmission resource of first information, and the first information is used to schedule transmission of first data. The processing unit is configured to send the first data based on the first information. The transceiver unit is further configured to receive second information. The second information is used to schedule transmission of second data. The processing unit is further configured to receive the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

In the fourth aspect of this application, a composition module of the communication apparatus may be further configured to: perform the steps performed in the possible implementations of the second aspect, and achieve corresponding technical effects. For details, refer to the second aspect. Details are not described herein again.

A fifth aspect of this application provides a communication apparatus, including at least one processor. The at least one processor is coupled to a memory, the memory is configured to store a program or instructions, and the at least one processor is configured to execute the program or the instructions, to enable the apparatus to implement the method according to any possible implementation in either of the first aspect and the second aspect.

A sixth aspect of this application provides a communication apparatus, including at least one logic circuit and an input/output interface. The logic circuit is configured to perform the method according to any possible implementation in either of the first aspect and the second aspect.

A seventh aspect of this application provides a communication system. The communication system includes the foregoing first communication apparatus and the foregoing second communication apparatus.

An eighth aspect of this application provides a computer-readable storage medium. The storage medium is configured to store one or more computer-executable instructions. When the computer-executable instructions are executed by a processor, the processor performs the method according to any possible implementation in either of the first aspect and the second aspect.

A ninth aspect of this application provides a computer program product (or referred to as a computer program). When the computer program in the computer program product is executed by a processor, the processor performs the method according to any possible implementation in either of the first aspect and the second aspect.

A tenth aspect of this application provides a chip system. The chip system includes at least one processor, configured to support a communication apparatus in implementing the method according to any possible implementation in either of the first aspect and the second aspect.

In a possible design, the chip system may further include a memory. The memory is configured to store program instructions and data that are necessary for the communication apparatus. The chip system may include a chip, or may include a chip and another discrete component. Optionally, the chip system further includes an interface circuit, and the interface circuit provides program instructions and/or data for the at least one processor.

For technical effects brought by any design manner in the third aspect to the tenth aspect, refer to technical effects brought by different design manners in the first aspect and the second aspect. Details are not described herein again.

### BRIEF DESCRIPTION OF THE DRAWINGS

FIG. 1a to FIG. 1c are diagrams of a communication system according to this application;

FIG. 1d, FIG. 1e, and FIG. 2a to FIG. 2f are diagrams of an AI processing process according to this application;

FIG. 3 is a diagram of interaction of a communication method according to this application;

FIG. 4a, FIG. 5, and FIG. 6 are diagrams of an AI processing process according to this application;

FIG. 4b to FIG. 4g are diagrams of interaction of a communication method according to this application; and

FIG. 7 to FIG. 11 are diagrams of an AI processing process according to this application.

### DETAILED DESCRIPTION OF ILLUSTRATIVE EMBODIMENTS

First, some terms in embodiments of this application are described for ease of understanding by a person skilled in the art.

(1) A terminal device may be a wireless terminal device that can receive scheduling and indication information of a network device. The wireless terminal device may be a device providing voice and/or data connectivity for a user, a handheld device having a wireless connection function, or another processing device connected to a wireless modem.

The terminal device may communicate with one or more core networks or the Internet through a radio access network (RAN). The terminal device may be a mobile terminal device such as a mobile telephone (also referred to as a “cellular” phone or a mobile phone), a computer, and a data card. For example, the terminal device may be a portable, pocket-sized, handheld, computer built-in, or vehicle-mounted mobile apparatus that exchanges voice and/or data with the radio access network. For example, the terminal device may be a device such as a personal communication service (PCS) phone, a cordless phone, a session initiation protocol (SIP) phone, a wireless local loop (WLL) station, a personal digital assistant (PDA), a tablet computer (Pad), or a computer having a wireless transceiver function. The wireless terminal device may also be referred to as a system, a subscriber unit, a subscriber station, a mobile station (MS), a remote station, an access point (AP), a remote terminal device (remote terminal), an access terminal device (access terminal), a user terminal device (user terminal), a user agent, a subscriber station device (subscriber station, SS), customer premises equipment (CPE), a terminal, user equipment (UE), a mobile terminal (MT), or the like.

As an example instead of a limitation, in embodiments of this application, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that can be directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement all or a part of functions without depending on smartphones, for example, smart watches or smart glasses, and include devices that are dedicated to only one type of application function and need to collaboratively work with other devices such as smartphones, for example, various smart bands, smart helmets, or smart jewelry for monitoring physical signs.

The terminal may alternatively be an uncrewed aerial vehicle, a robot, a terminal in device-to-device (D2D) communication, a terminal in vehicle-to-everything (V2X), a virtual reality (VR) terminal device, an augmented reality (AR) terminal device, a wireless terminal in industrial control, a wireless terminal in self driving, a wireless terminal in telemedicine (remote medical), a wireless terminal in smart grid, a wireless terminal in transportation safety, a wireless terminal in smart city, a wireless terminal in smart home, or the like.

In addition, the terminal device may alternatively be a terminal device in a communication system (for example, a 6th generation (6G) communication system) evolved after a 5th generation (5G) communication system, a terminal device in a future evolved public land mobile network (PLMN), or the like. For example, a 6G network may further extend a form and a function of a 5G communication terminal, and a 6G terminal includes but is not limited to a vehicle, a cellular network terminal (integrating a function of a satellite terminal), an uncrewed aerial vehicle, and an Internet of things (IoT) device.

In embodiments of this application, the terminal device may further obtain an AI service provided by a network device. Optionally, the terminal device may further have an AI processing capability.

(2) A network device may be a device in a wireless network. For example, the network device may be a RAN node (or device) connecting a terminal device to the wireless network, and may also be referred to as a base station. Currently, some examples of the RAN device are a base station, an evolved NodeB (eNodeB), a base station gNB (gNodeB) in a 5G communication system, a transmission reception point (TRP), an evolved NodeB (eNB), a radio network controller (RNC), a NodeB (NB), a home base station (for example, a home evolved NodeB, a home NodeB, or HNB), a baseband unit (BBU), a wireless fidelity (Wi-Fi) access point (AP), and the like. In addition, in a network structure, the network device may include a central unit (CU) node, a distributed unit (DU) node, or a RAN device including a CU node and a DU node.

Optionally, the RAN node may alternatively be a macro base station, a micro base station, an indoor base station, a relay node, or a donor node, or may be a radio controller in a cloud radio access network (CRAN) scenario. The RAN node may alternatively be a server, a wearable device, a vehicle, a vehicle-mounted device, or the like. For example, an access network device in a vehicle-to-everything (V2X) technology may be a road side unit (RSU).

In another possible scenario, a plurality of RAN nodes coordinate to assist the terminal in implementing radio access, and different RAN nodes separately implement a part of functions of the base station. For example, the RAN node may be a central unit (CU), a distributed unit (DU), a CU-control plane (control plane, CP), a CU-user plane (user plane, UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna processing unit (AAU), or a remote radio head (RRH).

In different systems, the CU (or the CU-CP and the CU-UP), the DU, or the RU may alternatively have different names, but a person skilled in the art may understand meanings thereof. For example, in an open access network (open RAN, O-RAN or ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

Communication between the access network device and the terminal device complies with a specific protocol layer structure. Protocol layers may include a control plane protocol layer and a user plane protocol layer. The control plane protocol layer may include at least one of the following: a radio resource control (RRC) layer, a packet data convergence protocol (PDCP) layer, a radio link control (RLC) layer, a media access control (MAC) layer, a physical (PHY) layer, or the like. The user plane protocol layer may include at least one of the following: a service data adaptation protocol (SDAP) layer, a PDCP layer, an RLC layer, a MAC layer, a physical layer, or the like.

For a correspondence between network elements in the ORAN system and protocol layer functions that may be implemented by the network elements, refer to Table 1.

TABLE 1

| | |
|---|---|
| ORAN network element | 3GPP protocol layer function |
| O-CU-CP | RRC + PDCP-control plane (PDCP-C) |
| O-CU-UP | SDAP + PDCP-user plane (PDCP-U) |
| O-DU | RLC + MAC + PHY-high |
| O-RU | PHY-low |

The network device may be another apparatus that provides a wireless communication function to the terminal device. A specific technology and a specific device form that are used by the network device are not limited in embodiments of this application. For ease of description, this is not limited in embodiments of this application.

The network device may further include a core network device. For example, the core network device includes network elements such as a mobility management entity (MME), a home subscriber server (HSS), a serving gateway (S-GW), a policy and charging rules function (PCRF), and a public data network gateway (PDN gateway, P-GW) in a 4th generation (4G) network, and an access and mobility management function (AMF), a user plane function (UPF), and a session management function (SMF) in a 5G network. In addition, the core network device may further include another core network device in the 5G network and a next generation network of the 5G network.

In embodiments of this application, the network device may alternatively be a network node having an AI capability, and may provide an AI service for a terminal or another network device, for example, may be an AI node, a computational power node, a RAN node having an AI capability, or a core network element having an AI capability on a network side (an access network or a core network).

In embodiments of this application, an apparatus configured to implement a function of the network device may be a network device, or may be an apparatus, for example, a chip system, that can support the network device in implementing the function. The apparatus may be installed in the network device. In the technical solutions provided in embodiments of this application, an example in which the apparatus configured to implement the function of the network device is a network device is used for describing the technical solutions provided in embodiments of this application.

(3) Configuration and preconfiguration: In this application, both the configuration and the preconfiguration are used. The configuration means that a network device/server sends configuration information of some parameters or values of parameters to a terminal by using a message or signaling, so that the terminal determines, based on the values or the information, a communication parameter or a resource used for transmission. Similar to the configuration, the pre-configuration may be parameter information or a parameter value negotiated by a network device/server with a terminal device in advance, or may be parameter information or a parameter value used by a base station/network device or a terminal device as specified in a standard protocol, or may be parameter information or a parameter value prestored in a base station/server or a terminal device. This is not limited in this application.

Further, these values and parameters may be changed or updated.

(4) Terms “system” and “network” in embodiments of this application may be used interchangeably. “A plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first” and “second” mentioned in embodiments of this application are used to distinguish between a plurality of objects, but are not used to limit a sequence, a time sequence, priorities, or importance of the plurality of objects.

(5) “Sending” and “receiving” in embodiments of this application represent signal transmission directions. For example, “sending information to XX” may be understood as that a destination end of the information is XX, and may include direct sending through an air interface, or may include indirect sending through an air interface by another unit or module. “Receiving information from YY” may be understood as that a source end of the information is YY, and may include direct receiving from YY through an air interface, or may include indirect receiving from YY through an air interface from another unit or module. The “sending” may alternatively be understood as “output” of a chip interface, and the “receiving” may alternatively be understood as “input” into the chip interface.

In other words, sending and receiving may be performed between devices, for example, between a network device and a terminal device; or may be performed inside a device, for example, sending or receiving between components, modules, chips, software modules, or hardware modules inside the device through a bus, a cable, or an interface.

It may be understood that necessary processing, such as encoding and modulation, may be performed on the information between the source at which the information is sent and the destination, but the destination may understand valid information from the source. Similar descriptions in this application may be understood similarly, and details are not described again.

(6) In embodiments of this application, “indication” may include a direct indication and an indirect indication, or may include an explicit indication and an implicit indication. Information indicated by a piece of information (for example, the following indication information) is referred to as to-be-indicated information. In a specific implementation process, the to-be-indicated information may be indicated in a plurality of manners, for example, but not limited to, directly indicating the to-be-indicated information, for example, indicating the to-be-indicated information, an index of the to-be-indicated information, or the like. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, specific information may alternatively be indicated by using an arrangement sequence of pieces of information that are pre-agreed on (for example, predefined in a protocol), to reduce indication overheads to some extent. A specific indication manner is not limited in this application. It may be understood that, for a sender of the indication information, the indication information may indicate to-be-indicated information, and for a receiver of the indication information, the indication information may be for determining to-be-indicated information.

In this application, unless otherwise specified, for same or similar parts of embodiments, mutual reference may be made between the embodiments. In embodiments of this application and methods/designs/implementations in embodiments, unless otherwise specified or logic conflicts occur, terms and/or descriptions between different embodiments and between the methods/designs/implementations in embodiments are consistent and may be mutually referenced, and different embodiments and technical features in the methods/designs/implementations in embodiments may be combined to form a new embodiment, method, or implementation based on an internal logic relationship thereof. The following implementations of this application do not constitute a limitation on the protection scope of this application.

This application may be applied to a long term evolution (LTE) system, a new radio (NR) system, or a communication system (for example, 6G) evolved after 5G. The communication system includes at least one network device and/or at least one terminal device.

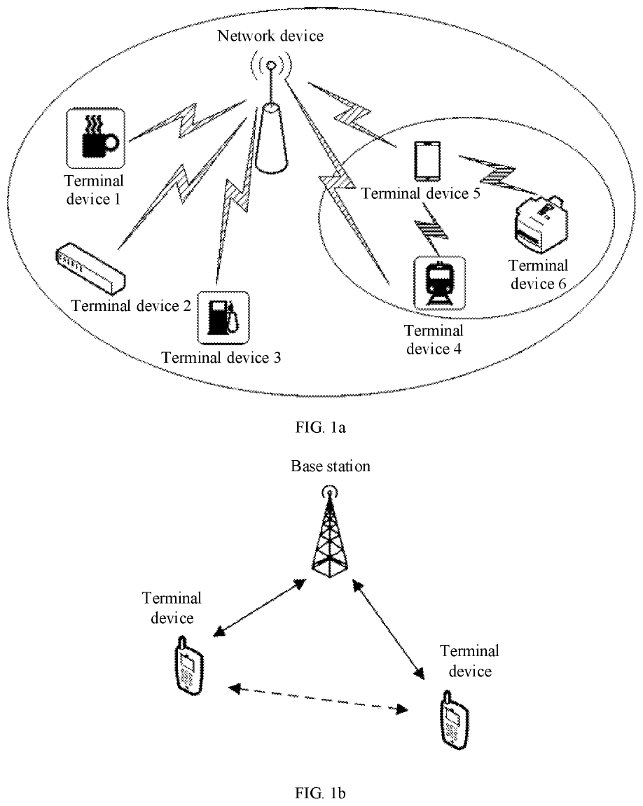

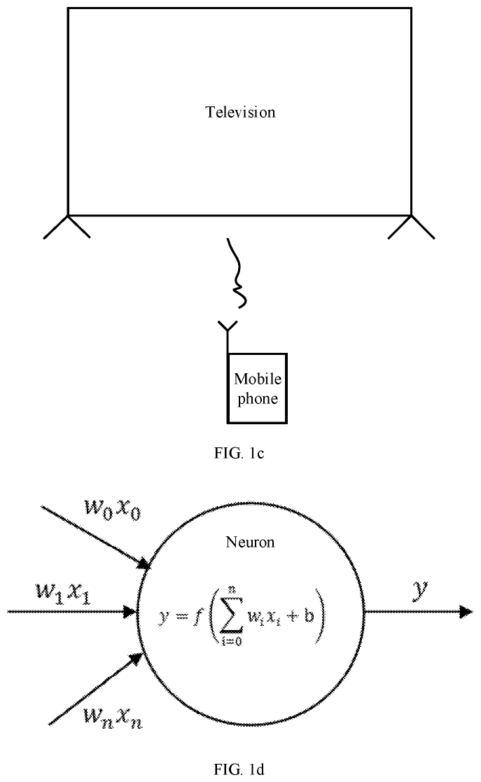

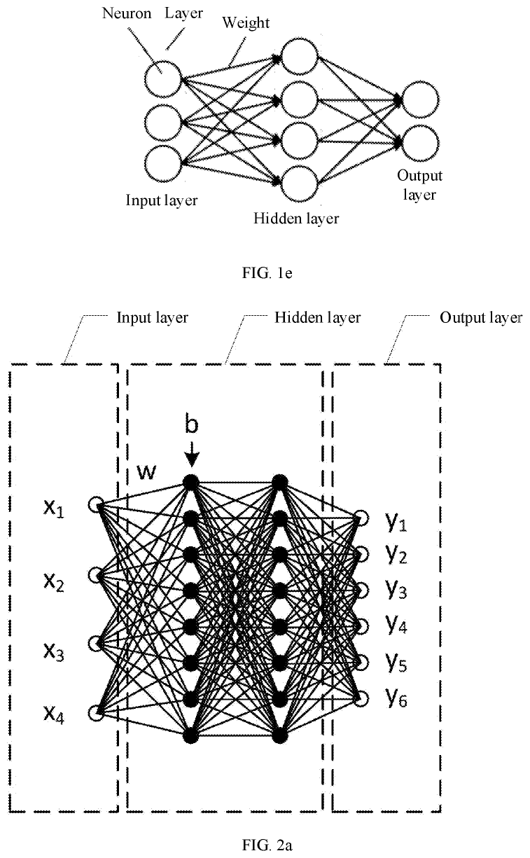

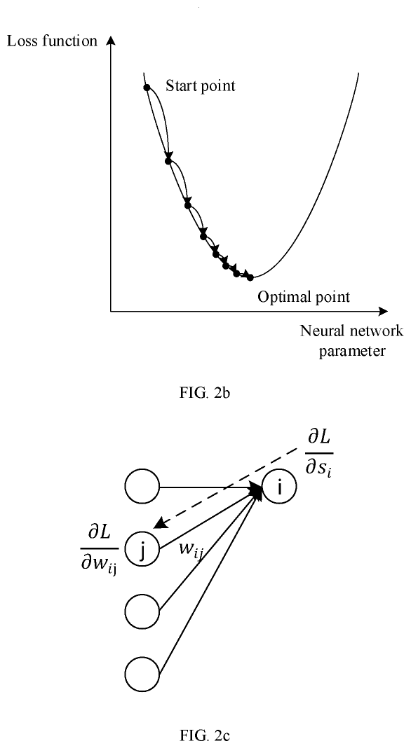

FIG. 1a is a diagram of a communication system according to this application. FIG. 1a shows an example of one network device and six terminal devices. The six terminal devices are a terminal device 1, a terminal device 2, a terminal device 3, a terminal device 4, a terminal device 5, and a terminal device 6. In the example shown in FIG. 1a, an example in which the terminal device 1 is a smart teacup, the terminal device 2 is a smart air conditioner, the terminal device 3 is a smart fuel dispenser, the terminal device 4 is a vehicle, the terminal device 5 is a mobile phone, and the terminal device 6 is a printer is used for description.

As shown in FIG. 1a, an AI configuration information sending entity may be the network device. AI configuration information receiving entities may be the terminal device 1 to the terminal device 6. In this case, the network device and the terminal device 1 to the terminal device 6 form a communication system. In the communication system, the terminal device 1 to the terminal device 6 may send data to the network device, and the network device needs to receive the data sent by the terminal device 1 to the terminal device 6. Besides, the network device may send configuration information to the terminal device 1 to the terminal device 6.

For example, in FIG. 1a, the terminal device 4 to the terminal device 6 may also form a communication system. The terminal device 5 serves as a network device, that is, an AI configuration information sending entity. The terminal device 4 and the terminal device 6 serve as terminal devices, that is, AI configuration information receiving entities. For example, in an internet of vehicles system, the terminal device 5 sends AI configuration information separately to the terminal device 4 and the terminal device 6, and receives data sent by the terminal device 4 and the terminal device 6; and correspondingly, the terminal device 4 and the terminal device 6 receive the AI configuration information sent by the terminal device 5, and send the data to the terminal device 5.

The communication system shown in FIG. 1a is used as an example. In addition to a communication-related service, an AI-related service may be performed between different devices (including between network devices, between a network device and a terminal device, and/or between terminal devices).

As shown in FIG. 1b, an example in which the network device is a base station is used. A communication-related service and an AI-related service may be performed between the base station and one or more terminal devices, and a communication-related service and an AI-related service may also be performed between different terminal devices.

As shown in FIG. 1c, an example in which terminal devices include a television and a mobile phone is used. A communication-related service and an AI-related service may also be performed between the television and the mobile phone.

The technical solutions provided in this application may be applied to a wireless communication system (for example, the system shown in FIG. 1a, FIG. 1b, or FIG. 1c). For example, an AI network element may be introduced to the communication system provided in this application to implement some or all AI-related operations. The AI network element may also be referred to as an AI node, an AI device, an AI entity, an AI module, an AI model, an AI unit, or the like. The AI network element may be built in a network element in the communication system. For example, the AI network element may be an AI module built in the access network device, the core network device, a cloud server, or a network management system (operation, administration and maintenance, OAM), to implement an AI-related function. The OAM may serve as a network management system of the core network device and/or as a network management system of the access network device. Alternatively, the AI network element may be an independently disposed network element in the communication system. Optionally, the terminal or the chip built in the terminal may alternatively include the AI entity, configured to implement the AI-related function.

The following briefly describes artificial intelligence (AI) that may be used in this application.

The artificial intelligence (AI) may enable machines to have human intelligence, for example, can enable the machines to use computer software and hardware to simulate some intelligent human behaviors. To implement the artificial intelligence, a machine learning method may be used. In the machine learning method, a machine obtains a model through learning (or training) by using training data. The model represents mapping from an input to an output. The model obtained through learning may be used for inference (or prediction). To be specific, the model may be used to predict an output corresponding to a given input. The output may also be referred to as an inference result (or a prediction result).

Machine learning may include supervised learning, unsupervised learning, and reinforcement learning. The unsupervised learning may also be referred to as non-supervised learning.

In terms of the supervised learning, based on collected sample values and sample labels, a mapping relationship between the sample values and the sample labels is learned by using a machine learning algorithm, and the learned mapping relationship is expressed by using an AI model. A process of training a machine learning model is a process of learning the mapping relationship. In the training process, a sample value is input into the model to obtain a predicted value of the model, and a model parameter is optimized by calculating an error between the predicted value of the model and a sample label (ideal value). After the mapping relationship is learned, a new sample label may be predicted by using the learned mapping. The mapping relationship learned through the supervised learning may include linear mapping or non-linear mapping. A learning task may be classified into a classification task and a regression task based on a type of a label.

In terms of unsupervised learning, an internal pattern of a sample is explored autonomously by using an algorithm based on a collected sample value. For a specific type of algorithm of the unsupervised learning, a sample is used as a supervised signal. In other words, a model learns a mapping relationship between samples, which is referred to as self-supervised learning. During training, a model parameter is optimized by calculating an error between a predicted value of the model and the sample. The self-supervised learning may be used for signal compression and decompression restoration. Common algorithms include an autoencoder, a generative adversarial network, and the like.

Reinforcement learning is different from supervised learning, and is an algorithm that learns a policy of resolving problems by interacting with an environment. Different from supervised learning and unsupervised learning, reinforcement learning does not have clear “correct” action label data. The algorithm needs to interact with the environment to obtain a reward signal fed back by the environment and adjust a decision action to obtain a larger reward signal value. For example, in downlink power control, a reinforcement learning model adjusts a downlink transmit power of each user based on a total system throughput fed back by a wireless network, to expect to obtain a higher system throughput. An objective of the reinforcement learning is also to learn a mapping relationship between an environment status and a better (for example, an optimal) decision action. However, a label of “correct action” cannot be obtained in advance. Therefore, a network cannot be optimized by calculating an error between an action and the “correct action”. Reinforcement learning training is implemented through iterative interaction with the environment.

A neural network (NN) is a specific model in a machine learning technology. According to a universal approximation theorem, the neural network can theoretically approximate any continuous function, so that the neural network has a capability of learning any mapping. In a conventional communication system, rich expertise is required to design a communication module. However, in a neural network-based deep learning communication system, an implicit pattern structure may be automatically discovered from a large quantity of datasets and a mapping relationship between data may be established, to obtain performance better than that of a conventional modeling method.

The idea of the neural network comes from a neuron structure of brain tissue. For example, each neuron performs a weighted summation operation on input values of the neuron, and outputs an operation result through an activation function.

FIG. 1d is a diagram of a neuron structure. It is assumed that an input of a neuron is x=[x₀, x₁, . . . , xₙ], and a weight corresponding to each input is w=[w, w₁, . . . , wₙ], where n is a positive integer, wᵢ and xᵢ may be various possible types such as a decimal, an integer (for example, 0, a positive integer, or a negative integer), or a complex number. wᵢ is used as a weight of xᵢ, and is used to weight xᵢ. A bias for performing weighted summation on the input values based on the weights is, for example, b. There may be a plurality of forms of the activation function. If an activation function of a neuron is y=f(z)=max(0, z), an output of the neuron is

$$y = f ( {\sum }_{i = 0}^{i = n} {w}_{i} * {x}_{i} + b ) = max ( 0 , {\sum }_{i = 0}^{i = n} {w}_{i} * {x}_{i} + b ) .$$

For another example, an activation function of a neuron is y=f(z)=z, and an output of the neuron is

$$y = f ( {\sum }_{i = 0}^{i = n} {w}_{i} * {x}_{i} + b ) = {\sum }_{i = 0}^{i = n} {w}_{i} * {x}_{i} + b .$$

b may be various possible types such as a decimal, an integer (for example, 0, a positive integer, or a negative integer), or a complex number. Activation functions of different neurons in the neural network may be the same or different.

In addition, the neural network usually includes a plurality of layers, and each layer may include one or more neurons. One or both of a depth and a width of the neural network are increased, so that an expression capability of the neural network can be improved, and a more powerful information extraction and abstraction modeling capability can be provided for a complex system. The depth of the neural network may be a quantity of layers included in the neural network, and a quantity of neurons included at each layer may be referred to as a width of the layer. In an implementation, the neural network includes an input layer and an output layer. The input layer of the neural network performs neuron processing on received input information, and transfers a processing result to the output layer. The output layer obtains an output result of the neural network. In another implementation, the neural network includes an input layer, a hidden layer, and an output layer. The input layer of the neural network performs neuron processing on received input information, and transfers a processing result to an intermediate hidden layer. The hidden layer performs calculation on the received processing result to obtain a calculation result. The hidden layer transfers the calculation result to the output layer or a next adjacent hidden layer. Finally, the output layer obtains an output result of the neural network. One neural network may include one hidden layer, or include a plurality of hidden layers that are sequentially connected. This is not limited.

The neural network is, for example, a deep neural network (DNN). According to a network construction manner, the DNN may include a feedforward neural network (FNN), a convolutional neural network (CNN), and a recurrent neural network (RNN).

FIG. 1e is a diagram of an FNN network. A feature of the FNN network is that neurons at adjacent layers are completely connected to each other. Due to this feature, the FNN usually needs a large amount of storage space, resulting in high computing complexity.

The CNN is a neural network dedicated to processing data of a similar grid structure. For example, both time series data (timeline discrete sampling) and image data (two-dimensional discrete sampling) may be considered as the data of the similar grid structure. The CNN performs a convolution operation by capturing partial information through a window with a fixed size, instead of performing an operation based on all input information at one time. This greatly reduces a calculation amount of a model parameter. In addition, based on different types of information captured through the window (for example, a person and an object in a same image are information of different types), different convolution kernel operations may be used for each window, so that the CNN can better extract a feature of input data.

The RNN is a DNN network using feedback time series information. Inputs of the RNN include a new input value at a current moment and an output value of the RNN at a previous moment. The RNN is suitable for obtaining a sequence feature having a time correlation, and is especially suitable for applications such as speech recognition and channel encoding and decoding.

In the foregoing model training process of machine learning, a loss function may be defined. The loss function describes a gap or a difference between an output value of the model and an ideal target value. The loss function may be expressed in a plurality of forms, and a specific form of the loss function is not limited. The model training process may be considered as the following process: A part or all of parameters of the model are adjusted, so that a value of the loss function is less than a threshold or meets a target requirement.

The model may also be referred to as an AI model, a rule, another name, or the like. The AI model may be considered as a specific method for implementing an AI function. The AI model represents a mapping relationship or a function between an input and an output of the model. The AI function may include one or more of the following: data collection, model training (or model learning), model information release, model deduction (also referred to as model inference, inference, prediction, or the like), model monitoring or model verification, inference result release, or the like. The AI function may also be referred to as an AI (AI-related) operation or an AI-related function.

The following describes an example of an implementation process of a neural network with reference to the accompanying drawings.

### 1. a Fully-Connected Neural Network is Also Referred to as a Multilayer Perceptron (MLP).

As shown in FIG. 2a, one MLP includes one input layer (left side), one output layer (right side), and a plurality of hidden layers (middle). Each layer of the MLP includes several nodes, which are referred to as neurons. Neurons at two neighboring layers are connected to each other in pairs.

Optionally, in consideration of neurons at two neighboring layers, an output h of a neuron at a lower layer is a weighted sum of all neurons x at an upper layer connected to the neuron at the lower layer, and may be expressed, by using an activation function, as:

$$h = f ( wx + b )$$

Herein, w is a weight matrix, b is a bias vector, and f is the activation function.

Further, optionally, the output of the neural network may be recursively expressed as:

$$y = {f}_{n} ( {w}_{n} {f}_{n - 1} ( ... ) + {b}_{n} )$$

Herein, n is an index of the neural network layer, 1≤n≤N, and N is a total quantity of layers of the neural network.

In other words, the neural network may be understood as a mapping relationship from an input dataset to an output dataset. The neural network is usually initialized randomly, and a process of obtaining the mapping relationship from random w and b based on existing data is referred to as training of the neural network.

Optionally, a specific training manner is to evaluate an output result of the neural network by using a loss function.

As shown in FIG. 2b, an error may be backpropagated, and neural network parameters (including w and b) can be iteratively optimized in a gradient descent method until the loss function reaches a minimum value, namely, “a better point (for example, an optimal point)” in FIG. 2b. It may be understood that the neural network parameter corresponding to “the better point (for example, the optimal point)” in FIG. 2b may be used as a neural network parameter in trained AI model information.

Further, optionally, a gradient descent process may be expressed as:

$$θ ← θ - η \frac{\partial L}{\partial θ}$$

Herein, θ is a to-be-optimized parameter (including w and b), L is the loss function, η is a learning rate for controlling a gradient descent step, ∂ represents a derivative operation, and

$$\frac{\partial L}{\partial θ}$$

represents a derivative of L with respect to θ.

Further, optionally, a backpropagation process uses a chain rule for finding a partial derivative.

As shown in FIG. 2c, a gradient of a parameter at a previous layer may be obtained by recursive calculation of a gradient of a parameter at a next layer, and may be expressed as:

$$\frac{\partial L}{\partial {w}_{ij}} = \frac{\partial L}{\partial {s}_{i}} \frac{\partial {s}_{i}}{\partial {w}_{ij}}$$

Herein, wᵢⱼ is a weight of a connection between the node j and the node i, and sᵢ is a weighted sum of inputs into the node i.

### 2. Federated Learning (FL)

A concept of the federated learning is proposed to effectively resolve difficulties faced by current development of artificial intelligence. While ensuring user data privacy and security, the federated learning facilitates various edge devices and a server at a central end to collaborate to efficiently complete a learning task of a model.

As shown in FIG. 2d, an FL architecture is a currently most widely used training architecture in the FL field. A FedAvg algorithm is a basic algorithm of FL. An algorithm procedure of the FedAvg algorithm is roughly as follows:
(1) The central end initializes a to-be-trained model

$${w}_{g}^{0}$$

and broadcasts and sends the model to all client devices
(2) In a t^{th} (t∈[1, T]) round, a client k∈[1, K] performs E epochs of training on a received global model

$${w}_{g}^{t - 1}$$

based on a local dataset [symbol] ₖ to obtain a local training result

$${w}_{k}^{t} ,$$

and reports the local training result to a central node.
(3) The central node summarizes and collects local training results from all (or some) clients. It is assumed that a set of clients that upload a local model in a t^{th} round is [symbol] ^{t}. The central end performs weighted averaging by using a quantity of samples of a corresponding client as a weight to obtain a new global model, and a specific update rule is

$${w}_{g}^{t} = {\sum }_{k ∈ {𝒮}^{t}} \frac{{D}_{k} {w}_{k}^{t}}{{\sum }_{k ∈ {𝒮}^{t}} {D}_{k}} .$$

Then, the central end broadcasts and sends a global model

$${w}_{g}^{t}$$

of a latest version to all client devices for a new round of training.
(4) Steps (2) and (3) are repeated until the model converges finally or a quantity of training rounds reaches an upper limit.

In addition to reporting the local model wₖ^{t}, a trained local gradient gₖ^{t} may also be reported. The central node averages the local gradient, and updates the global model based on a direction of the average gradient.

It can be learned that, in the FL framework, a dataset exists on a distributed node. To be specific, the distributed node collects a local dataset, performs local training, and reports a local result (a model or a gradient) obtained through training to the central node. The central node does not have a dataset, is only responsible for fusing training results of distributed nodes to obtain a global model, and delivers the global model to the distributed nodes.

### 3. Decentralized Learning: Unlike Federated Learning, Another Distributed Learning Architecture is Decentralized Learning.

As shown in FIG. 2e, a fully distributed system without a central node is considered. A design target f(x) of a decentralized learning system is usually an average value of targets fᵢ(x) of all nodes, that is,

$$f ( x ) = \frac{1}{n} {\sum }_{i = 1}^{n} {f}_{i} ( x ) ,$$

where n is a quantity of distributed nodes, x is a to-be-optimized parameter, and in machine learning, x is a parameter of a machine learning (for example, a neural network) model. Each node calculates a local gradient ∇fᵢ(x) based on local data and the local target fᵢ(x), and then sends the local gradient to a neighboring node that is reachable in communication. After receiving gradient information sent by a neighboring node of any node, the node may update a parameter x of a local model based on the following formula:

$${x}_{i}^{k + 1} = {x}_{i}^{k} - {α}_{k} ( \frac{1}{\vert {N}_{i} \vert} {\sum }_{j ∈ {N}_{i}} ∇ {f}_{j} ( {x}_{j}^{k} ) )$$

Herein,

$${x}_{i}^{k + 1}$$

represents a parameter that is of the local model and that is obtained through a (k+1)^{th} (k is a natural number) time of updating in an i^{th} node,

$${x}_{i}^{k}$$

represents a parameter that is of the local model and that is obtained through a k^{th} time of updating in the i^{th} node (if k is 0, it represents that

$${x}_{i}^{k}$$

is a parameter that is of the local model and that exists before updating in the i^{th} node), αₖ represents an optimization coefficient, Nᵢ is a set of neighboring nodes of the node i, and |Nᵢ| represents a quantity of elements in the set of neighboring nodes of the node i, namely, a quantity of neighboring nodes of the node i. Through information exchange between nodes, the decentralized learning system will finally learn a unified model.

The technical solutions provided in this application may be applied to a wireless communication system (for example, the system shown in FIG. 1a or FIG. 1b). In the wireless communication system, a communication node usually has a signal receiving and sending capability and a computing capability. A network device having a computing capability is used as an example. The computing capability of the network device is mainly providing computational power support for a signal receiving and sending capability (for example, performing sending processing and receiving processing on a signal), to implement a communication task between the network device and another communication node.

In a communication network, in addition to providing computational power support for the foregoing communication task based on the computing capability of the communication node, the communication node may further have a surplus computing capability. Therefore, how to use these computing capabilities is an urgent technical problem to be resolved.

In a possible implementation, the communication node may serve as a participating node of an AI learning system, and computational power of the communication node is applied to a phase of the AI learning system. With advent of the large model era, a deep learning model with massive parameters, for example, bidirectional encoder representation from transformers (BERT) or a generative pre-trained transformer (GPT), can complete increasingly complex tasks and achieve better performance. However, for a large model, even an inference process of the model is limited by a device capacity. Therefore, the large model is usually stored on a cloud central server. In addition, each device in a network generates a large amount of raw data every day, and the data needs to invoke the large model a plurality of times for inference. Usually, the device (for example, the communication node) may send data to a central server, the central server performs inference based on the data, and then the central server returns an inference result to the device. This process consumes a large quantity of communication resources for data transmission, and privacy of device data is at risk.

A scholar proposes a distributed inference technology of the deep neural network, to better reduce communication overheads and protect user data privacy. The model is distributed to the device, and local computational power of the device is used to infer the model, to reduce communication overheads and obtain data privacy preserving.

For example, in an example shown in FIG. 2f, two communication nodes, namely, a node 1 and a node 2, participate in the AI learning system. The node 1 and the node 2 each may be a communication node, for example, a terminal device or a network device. A neural network used in the AI learning system may include at least a neural sub-network that is deployed on the node 1 and that is used for AI encoding, and/or a neural sub-network that is deployed on the node 2 and that is used for AI decoding.

In an implementation example of FIG. 2f, after the node 1 performs processing based on the neural sub-network used for AI encoding to obtain an encoding result, a radio signal is obtained after quantization and physical layer processing are performed on the encoding result. Correspondingly, after the node 2 receives the radio signal through transmission on a radio channel, the node 2 performs physical layer processing and dequantization processing, and then uses a processing result as an input for AI decoding. The decoding result can be obtained through AI decoding processing. In addition, the node 2 may further determine gradient data based on the decoding result and label data.

Then, after the node 2 obtains the gradient data through neural sub-network processing based on AI decoding, quantization and physical layer processing are performed on the gradient data to obtain a radio signal. Correspondingly, after the node 1 receives the radio signal through transmission on a radio channel, the node 1 obtains the gradient data through physical layer processing and dequantization processing. Subsequently, the node 1 can perform, based on the gradient data, neural network optimization (for example, training/updating/iteration) on the neural sub-network that is deployed on the node 1 and that is used for AI encoding.

Optionally, after the node 2 obtains the gradient data, the node 2 can also perform, based on the gradient data, neural network optimization (for example, training/updating/iteration) on the neural sub-network that is deployed on the node 2 and that is used for AI encoding.

It should be noted that, the node 2 may further calculate a result of a loss function based on the decoding result and the label data, and the result of the loss function may also be used for neural network optimization. The foregoing implementation is described by using only an example in which the node 2 determines the gradient data.

However, in the foregoing implementation process, neural network processing (for example, a processing process of the neural sub-network that is deployed on the node 1 and that is used for AI encoding, and the neural sub-network that is deployed on the node 2 and that is used for AI decoding) and communication (for example, physical layer processing) are two independent operations, and are separately completed at different protocol layers. Therefore, a large quantity of steps are required, and a delay is high.

To resolve the foregoing problem, this application provides a communication method and a related device, so that computational power of a communication node can be applied to artificial intelligence (AI) processing of a neural network, and flexibility of neural network deployment can be improved. The following provides detailed descriptions with reference to the accompanying drawings.

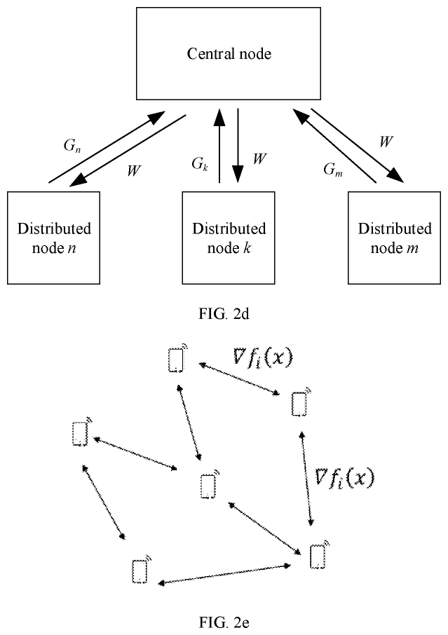

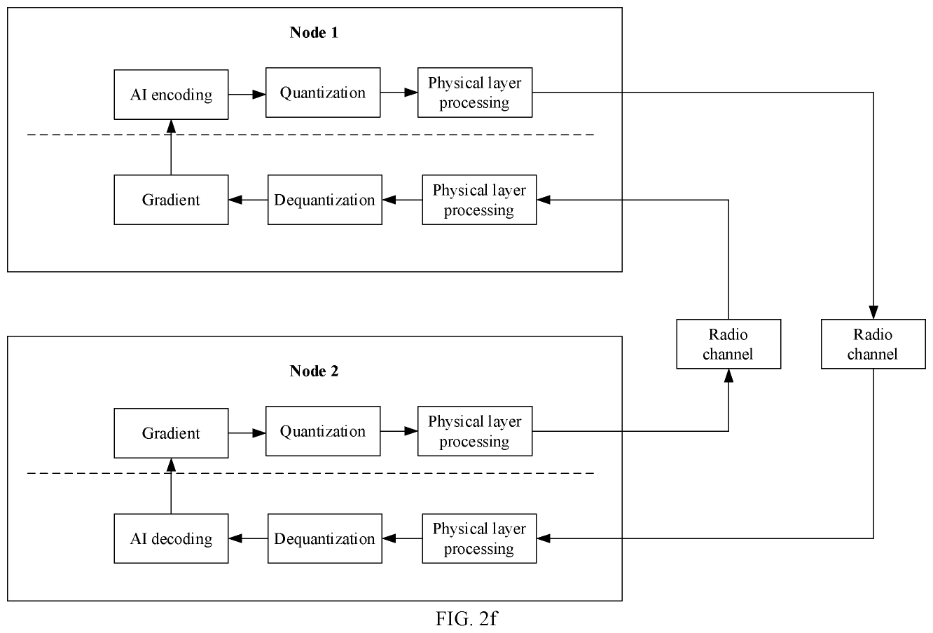

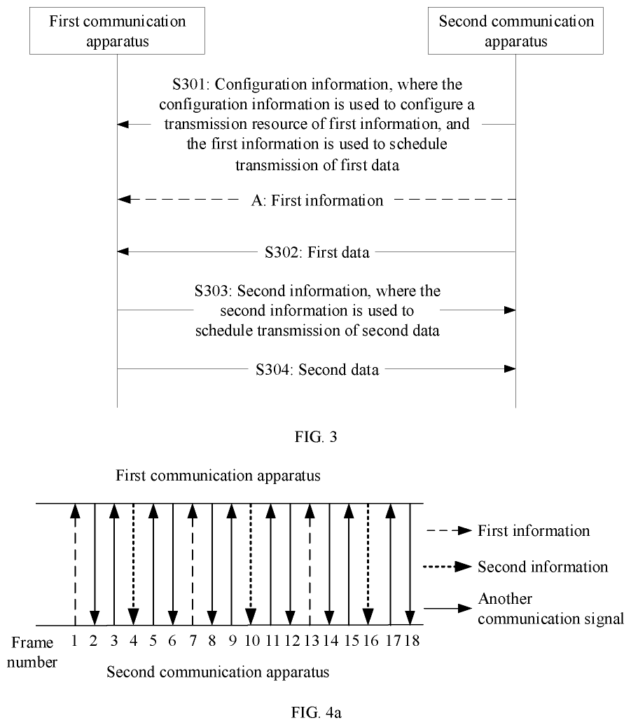

FIG. 3 is a diagram of an implementation of a communication method according to this application. The method includes the following steps.

It should be noted that in FIG. 3, an example in which a first communication apparatus and a second communication apparatus are used as execution bodies of the interaction example is used to illustrate the method. However, the execution body of the interaction example is not limited in this application. For example, in FIG. 3 and FIG. 6 below, an execution body of the method may be replaced with a chip, a chip system, a processor, a logical module, software, or the like in the communication apparatus. The first communication apparatus may be a terminal device, and the second communication apparatus may be a network device. Alternatively, both the first communication apparatus and the second communication apparatus are terminal devices (for example, the method may be applied to a communication process of different terminal devices in a sidelink communication scenario).

S301: The second communication apparatus sends configuration information, and correspondingly, the first communication apparatus receives the configuration information. The configuration information is used to configure a transmission resource of first information, and the first information is used to schedule transmission of first data.

It should be understood that, after the second communication apparatus sends, in step S301, the configuration information used to configure the transmission resource of the first information, the second communication apparatus may send the first information based on the configuration information. Correspondingly, the first communication apparatus may receive the first information based on the configuration information (for example, an implementation process of step A in FIG. 3).

S302: The second communication apparatus sends first data, and correspondingly, the first communication apparatus receives the first data.

S303: The first communication apparatus sends second information, and correspondingly, the second communication apparatus receives the second information. The second information is used to schedule transmission of second data.

S304: The first communication apparatus sends the second data, and correspondingly, the first communication apparatus receives the second data.

In this application, terms such as AI, neural network, AI neural network, machine learning, AI processing, and AI neural network processing may be replaced with each other.

In this application, related data (for example, the first data and the second data) may be replaced with information, a signal, or the like.

It should be understood that, in a wireless communication system, one or both of the first information used to schedule the first data and the second information used to schedule the second data may be a message/signaling/information of a radio resource control (RRC) layer, a medium access control (MAC) layer, a physical (PHY) layer, or another protocol layer.

In addition, compared with an implementation in which the communication apparatus performs physical layer processing on received application layer data and then dequantizes a physical layer processing result to obtain application layer scheduling signaling (the scheduling signaling is used to schedule transmission of data associated with AI processing), when one or both of the first information used to schedule the first data and/or the second information used to schedule the second data are physical layer signaling, transmission of data associated with AI processing can be quickly scheduled by using the physical layer signaling, thereby reducing a processing delay.

For example, the first information used to schedule the first data is from the second communication apparatus. The second communication apparatus may be a network device. Correspondingly, the first information may be downlink control information (DCI) sent by the network device to the terminal device, and the second information may be uplink control information (UCI) sent by the terminal device to the network device. Alternatively, the second communication apparatus may be another terminal device different from the first communication apparatus. Correspondingly, the first information and the second information may be sidelink control information (SCI) exchanged between different terminal devices.

It should be noted that, the first data may be data obtained through first processing and the second data may be gradient data obtained based on data obtained by performing second processing on the first data and label data; or the second data is data obtained through first processing and the first data is gradient data obtained based on data obtained by performing second processing on the second data and label data. In other words, the first data may be obtained based on the second data, or the second data may be obtained based on the first data. In other words, there may be a plurality of manners of execution sequences of step S302 and step S304. The following describes the execution sequences by using some implementation examples.

In Implementation 1, step S302 is performed before step S304. In this case, the second data may be data obtained based on the first data. For example, when the first data is the data obtained through the first processing and the second data is the gradient data obtained based on the data obtained by performing the second processing based on the first data and the label data, the first data is data sent by a sender (for example, the second communication apparatus) of the first data after the first processing is performed, and the second data is data obtained by the first communication apparatus by performing the second processing based on the received first data.

In other words, in Implementation 1, the first communication apparatus performs the first processing to obtain the first data, and the second communication apparatus performs the second processing to obtain the second data. In this case, the first data may be referred to as forward data, and the second data may be referred to as backward data (for example, a backward gradient, or a result of a loss function).

It may be understood that, in Implementation 1, step S302 is performed before step S304, the first information used to schedule the first data is performed before step S302, and the second information (namely, step S303) used to schedule the second data is performed before step S304. In addition, an execution sequence of a receiving and sending process of the first data in step S302 and a receiving and sending process of the second information in step S303 is not limited. For example, step S302 is performed before step S303. For another example, step S303 is performed before step S302.

In Implementation 2, step S304 is performed before step S302. In this case, the first data may be data obtained based on the second data. For example, when the second data is data obtained through the first processing and the first data is the gradient data obtained based on the data obtained by performing the second processing based on the second data and the label data, the second data is data sent by the first communication apparatus after the first processing is performed, and the first data is data obtained by a sender (for example, a second communication apparatus) of the first data by performing the second processing based on the received second data.

In other words, in Implementation 2, the second communication apparatus performs the first processing to obtain the first data, and the first communication apparatus performs the second processing to obtain the second data. In this case, the second data may be referred to as forward data, and the first data may be referred to as backward data (for example, a backward gradient, or a result of a loss function).

It may be understood that, in Implementation 2, step S304 is performed before step S302, the first information used to schedule the first data is performed before step S302, and the second information (namely, step S303) used to schedule the second data is performed before step S304. In addition, an execution sequence of a receiving and sending process of the second data in step S304 and a receiving and sending process of the first information is not limited. For example, step S304 is performed before the receiving and sending process of the first information. For another example, the receiving and sending process of the first information is performed before step S304.

Optionally, in Implementation 1 and Implementation 2, an execution sequence between the receiving and sending process of the second information and the receiving and sending process of the first information in step S304 is not limited. For example, step S304 is performed before the receiving and sending process of the first information. For another example, the receiving and sending process of the first information is performed before step S304.

It should be understood that, in Implementation 1 or Implementation 2, the first processing performed by the first communication apparatus or the second communication apparatus may include AI processing, and/or the second processing performed by the first communication apparatus or the second communication apparatus may include AI processing. For example, if the first processing includes AI processing, the AI processing in the first processing may be referred to as encoding neural network processing, AI encoder processing, AI encoding neural network processing, or the like. Correspondingly, if the second processing includes AI processing, the AI processing in the second processing may be referred to as decoding neural network processing, AI decoder processing, AI decoding neural network processing, or the like.

It can be learned from the implementation process in Implementation 1 and the implementation process in Implementation 2 that after the first communication apparatus receives the configuration information in step S301, there may be an association relationship between the first information received by the first communication apparatus based on the configuration information and the second information sent by the first communication apparatus in step S303. The association relationship may have a plurality of implementations. The following provides example descriptions by using Implementation A and Implementation B.

Implementation A: A time interval between a time domain resource carrying the first information and a time domain resource carrying the second information is preconfigured.

Specifically, in step S301 in which the first communication apparatus receives the configuration information, the transmission resource of the first information includes a time domain resource carrying the first information, and a time interval between the time domain resource carrying the first information and a time domain resource carrying the second information is preconfigured.

In this manner, when the receiving and sending process of the first information is performed before the receiving and sending process of the second information, after the first communication apparatus determines, based on the configuration information in step S301, the time domain resource carrying the first information, the first communication apparatus can receive the first information based on the time domain resource carrying the first information, and the first communication apparatus can determine, based on the preconfigured time interval and the time domain resource carrying the first information, the time domain resource carrying the second information. Then, after the first communication apparatus receives the first information, the first communication apparatus can send the second information on the time domain resource carrying the second information. In addition, the second communication apparatus can receive the second information based on the preconfigured time interval, to reduce resource configuration overheads of the second information.

Similarly, when the receiving and sending process of the second information is performed before the receiving and sending process of the first information, after the first communication apparatus determines the time domain resource for the first information based on the configuration information in step S301, the first communication apparatus can determine, based on the preconfigured time interval before the time domain resource for carrying the first information, the time domain resource carrying the second information. Then, after the first communication apparatus can send the second information on the time domain resource carrying the second information, the first communication apparatus receives the first information on the time domain resource carrying the first information. In addition, the second communication apparatus can also implement receiving of the second information and sending of the first information based on the preconfigured time interval.

Optionally, Implementation A may be understood as a real-time data alignment manner. “Real-time” herein may be understood as that a time interval between a process in which the first communication apparatus receives the first information and a process in which the first communication apparatus sends the second information is relatively fixed; and/or a time interval between a process in which the first communication apparatus performs processing (for example, the first processing or the second processing) to obtain the second data and a process in which the second communication apparatus performs processing (for example, the first processing or the second processing) to obtain the first data is relatively fixed.

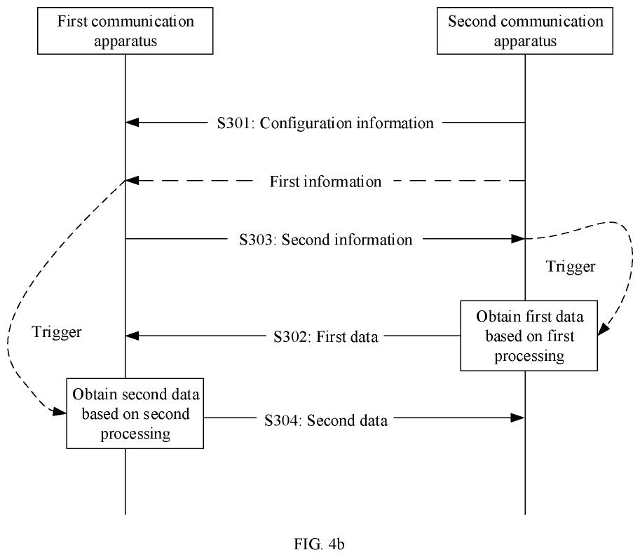

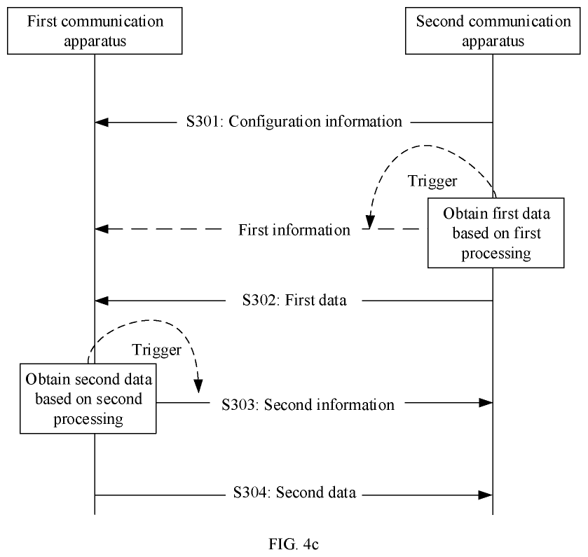

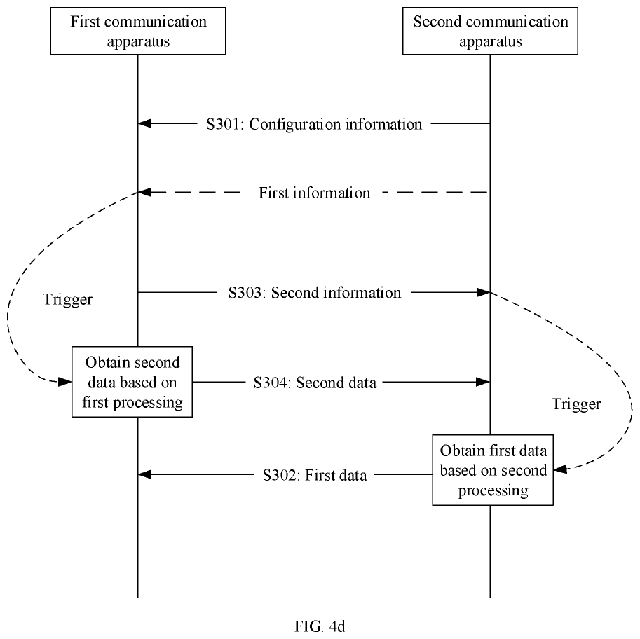

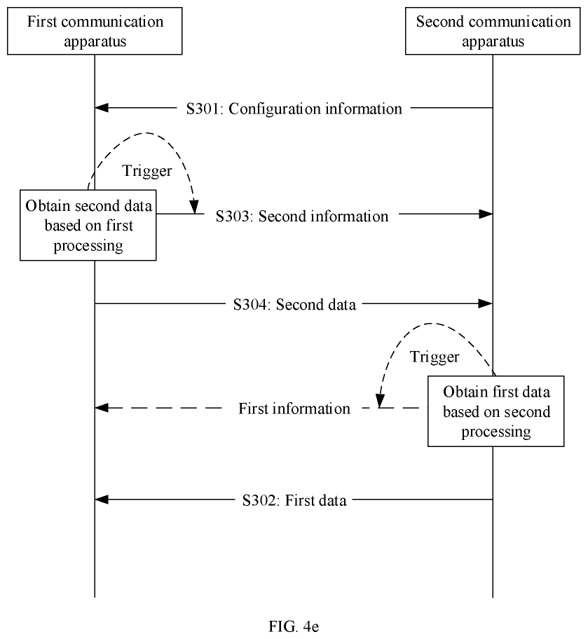

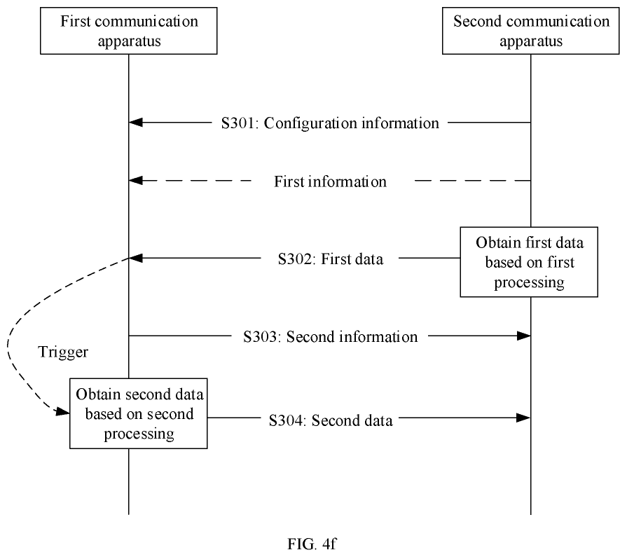

FIG. 4a shows an implementation example of Implementation A (namely, the real-time data alignment manner). In this example, a 1^{st} frame (for example, a frame whose frame number is Jan. 7, 2013) in every six frames is used to transmit the first information sent by the second communication apparatus, and a 4^{th} frame (for example, a frame whose frame number is Apr. 10, 2016) in every six frames is used to transmit the second information sent by the first communication apparatus. In other words, the time interval between the time domain resource carrying the first information and the time domain resource carrying the second information is preconfigured.

It may be understood that, in FIG. 4a, in addition to the configuration information, the first information, the first data, the second information, and the second data, the first communication apparatus and the second communication apparatus may further exchange other data, for example, another communication signal shown in FIG. 4a, for example, system information, a reference signal, and channel information obtained through measurement based on the reference signal.

In a possible implementation of Implementation A, the first communication apparatus may send indication information to the second communication apparatus (or receive indication information from the second communication apparatus). The indication information indicates the time interval between the time domain resource carrying the first information and the time domain resource carrying the second information. In this manner, the first communication apparatus and the second communication apparatus can align understandings of the time interval, to avoid a transmission error.

Optionally, when the indication information (the indication information indicates the time interval) from the second communication apparatus is received, the indication information may be carried in the configuration information in step S301.

Implementation B: Either of the first information and the second information and either of the first processing and the second processing may be mutually triggered.

In Implementation example 1 of Implementation B, when the first data is the data obtained through the first processing and the second data is the gradient data obtained based on the data obtained by performing the second processing based on the first data and the label data (namely, in a case of Implementation 1), the second processing is triggered based on the first information and the first processing is triggered based on the second information; or the first information is triggered based on the first processing and the second information is triggered based on the second processing.

As shown in an implementation process in FIG. 4b, in Implementation example 1 of Implementation example B, when the second processing is triggered based on the first information and the first processing is triggered based on the second information, the receiving and sending process of the second information (namely, step S303) is performed before the receiving and sending process of the first data obtained through the first processing (namely, step S302), and the receiving and sending process of the first information is performed before the receiving and sending process of the second data obtained through the second processing (namely, step S304).

In an implementation process shown in FIG. 4c, in Implementation example 1 of Implementation example B, when the first information is triggered based on the first processing and the second information is triggered based on the second processing, the second communication apparatus triggers the receiving and sending process of the first information in a process of obtaining the first data based on the first processing, and then subsequently sends the first data (namely, step S302). In addition, the first communication apparatus triggers the receiving and sending process of the second information (namely, step S303) in a process of obtaining the second data based on the second processing, and then subsequently sends the second data (namely, step S304).

In Implementation example 2 of Implementation B, when the second data is the data obtained through the first processing and the first data is the gradient data obtained based on the data obtained by performing the second processing based on the second data and the label data (namely, in a case of Implementation 2), the second processing is triggered based on the second information and the first processing is triggered based on the first information; or the first information is triggered based on the second processing and the second information is triggered based on the first processing.

In an implementation process shown in FIG. 4d, in Implementation example 2 of Implementation example B, when the second processing is triggered based on the second information and the first processing is triggered based on the first information, after receiving the first information, the first communication apparatus triggers obtaining of the second data based on the first processing, and performs step S304. Correspondingly, after receiving the second information in step S303, the second communication apparatus triggers obtaining of the first data based on the second processing, and performs step S302.

In an implementation process shown in FIG. 4e, in Implementation example 2 of Implementation example B, when the second information is triggered based on the first processing and the first information is triggered based on the second processing, in a process of obtaining the second data based on the first processing, the first communication apparatus triggers a process of sending the second information in step S303. In addition, in a process of obtaining the first data based on the second processing, the second communication apparatus triggers a process of sending the first information.

In Implementation example 1 and Implementation example 2, because the first processing includes AI processing, and/or the second processing includes AI processing, scheduling of AI data can be triggered by AI processing in the foregoing implementation, or AI processing can be triggered by scheduling of AI data in the foregoing implementation. Therefore, AI processing and scheduling of AI data can be mutually triggered, thereby reducing interaction of an AI processing triggering indication or an AI data scheduling triggering indication, and reducing a processing delay and overheads.

In Implementation example 3 of Implementation B, when the first data is the data obtained through the first processing and the second data is the gradient data obtained based on the data obtained by performing the second processing based on the first data and the label data (namely, in a case of Implementation 1), the second processing is triggered based on the first data.

In an implementation process shown in FIG. 4f, in Implementation example 3 of Implementation example B, when the second processing is triggered based on the first data, after the first communication apparatus receives the first data in step S302, the first communication apparatus triggers obtaining of the second data based on the second processing.

Optionally, in Implementation example 3, that the second processing is triggered based on the first data includes: The second processing is triggered based on the first information and the first data. To be specific, after the first communication apparatus confirms receiving of the first information and the first data, the first communication apparatus triggers obtaining of the second data based on the second processing.

In Implementation example 4 of Implementation B, when the second data is the data obtained through the first processing and the first data is the gradient data obtained based on the data obtained by performing the second processing based on the second data and the label data (namely, in a case of Implementation 2), the second processing is triggered based on the second data.

In an implementation process shown in FIG. 4g, in Implementation example 4 of Implementation example B, when the second processing is triggered based on the second data, after the second communication apparatus receives the second data in step S304, the second communication apparatus triggers obtaining of the first data based on the second processing.

Optionally, in Implementation example 4, that the second processing is triggered based on the second data includes: The second processing is triggered based on the second information and the second data. To be specific, after the second communication apparatus confirms receiving of the second information and the second data, the second communication apparatus triggers obtaining of the first data based on the first processing.

In Implementation example 3 and Implementation example 4, because the first processing includes AI processing, and/or the second processing includes AI processing, the AI processing can be triggered by transmission of AI data in the foregoing implementations. Therefore, AI processing and transmission of AI data can be mutually triggered, thereby reducing interaction of an AI processing trigger indication, reducing a processing delay, and reducing overheads.

FIG. 5 is a scenario example of Implementation B. In this example, implementation scenarios of Implementation example 1 and Implementation example 3 are used as an example. To be specific, the first data is the data obtained through the first processing and the second data is the gradient data obtained based on the data obtained by performing the second processing based on the first data and the label data. In addition, in this example, that the first communication apparatus is a terminal device configured to perform the second processing and the second communication apparatus is a network device configured to perform the first processing is used as an example. In other words, that the first information is DCI and the second information is UCI is used as an example.

It can be learned from an implementation process in FIG. 5 that, in Implementation Example 1, after the network device sends DCI through a downlink transmit link, the terminal device may receive the DCI through the downlink receive link, and the terminal device may trigger the second processing based on the DCI. Similarly, after the terminal device sends UCI through an uplink transmit link, the network device may receive the UCI through the uplink receive link, and the network device may trigger the first processing based on the UCI. In Implementation example 3, after the network device sends the first data through a downlink transmit link, the terminal device may receive the first data through a downlink receive link, and the terminal device may trigger the second processing based on the first data. Similarly, after the terminal device sends the second data through an uplink transmit link, the network device may receive the second data through an uplink receive link, and the network device may trigger the first processing based on the second data.

Optionally, Implementation B may be understood as a data synchronization manner in a non-real-time system. “Non-real-time” herein may be understood as that a time interval between a process in which the first communication apparatus receives the first information and a process in which the first communication apparatus sends the second information is not relatively fixed; and/or a time interval between a process in which the first communication apparatus performs processing (for example, the first processing or the second processing) to obtain the second data and a process in which the second communication apparatus performs processing (for example, the first processing or the second processing) to obtain the first data is not relatively fixed.

FIG. 6 shows an implementation example of Implementation B (namely, a non-real-time data alignment manner). In this example, a plurality of AI tasks may be executed between the first communication apparatus and the second communication apparatus, and execution periodicities of different AI tasks or triggering of data receiving and sending of different AI tasks may be different. For example, sizes of first data of different AI tasks may be different. For another example, sizes of second data of different AI tasks may be different.

In the example shown in FIG. 6, scheduling information related to an AI task may include first information transmitted on a time resource whose frame number is 1 and second information transmitted on a time resource whose frame number is 4. In other words, an interval between the two time resources is two frames (namely, frames whose frame numbers are 2 and 3). Data related to another AI task may be first information transmitted on a time resource whose frame number is 5 and second information transmitted on a time resource whose frame number is 10. In other words, an interval between the two time resources is four frames (namely, frames whose frame numbers are 6, 7, 8, and 9). Data related to another AI task may include first information transmitted on a time resource whose frame number is 17 and second information transmitted on a time resource whose frame number is 18. In other words, an interval between the two time resources is 0 frames (namely, the two time resources are two adjacent frames).

In a possible implementation of Implementation B, the configuration information received by the first communication apparatus in step S301 includes a first configuration and a second configuration, the first configuration is used to configure a search space of the first information, and the second configuration is used to configure a retransmission timer of the second information; and a time length of a periodicity corresponding to the search space is less than or equal to a time length of the retransmission timer. In this manner, the first communication apparatus can implement receiving of the first information and retransmission of the second information based on the configuration information, thereby improving a transmission success rate of the first information and a transmission success rate of the second information.

In addition, because the first information and AI processing may be mutually triggered, that is, the first information may be executed aperiodically, in an implementation in which the time length of the periodicity corresponding to the search space is less than or equal to the time length of the retransmission timer, the first communication apparatus can detect the first information in a periodicity with a short time length, so that the first communication apparatus can implement receiving of data obtained through AI processing in a timely manner or implement triggering of AI processing in a timely manner. In addition, a timer with a long time length can reduce overheads of retransmitting the second information by the first communication apparatus.

Implementation C: The first information and the first data may be mutually triggered, and/or the second information and the second data may be mutually triggered.

In an implementation example of Implementation C, a process in which the second communication apparatus sends the first information may be used to trigger generation of the first data or sending of the first data. Similarly, a process in which the first communication apparatus sends the second information may be used to trigger generation of the second data or sending of the second data.

In another implementation example of Implementation C, a process in which the second communication apparatus generates or sends the first data may trigger a process in which the second communication apparatus sends the first information. Similarly, a process in which the first communication apparatus generates or sends the second data may trigger a process in which the first communication apparatus sends the second information.

It should be noted that, for a triggering process in Implementation C, refer to the foregoing descriptions of Implementation B (for example, the implementation examples in FIG. 4b to FIG. 4g).

In a possible implementation, after the first communication apparatus receives the first information based on the configuration information in step S301, the method further includes: The first communication apparatus sends first indication information. The first indication information indicates whether the first information is correctly received.

In this application, whether being correctly received may be replaced with a description of another term, including but not limited to: whether being incorrectly received, whether being correctly parsed, or whether being incorrectly parsed. Specifically, the first communication apparatus may further send the first indication information, so that the second communication apparatus can determine, based on the first indication information, whether the first communication apparatus correctly receives the first information. Subsequently, the second communication apparatus may determine, based on the first indication information, whether to retransmit the first information and/or the first data scheduled based on the first information.

In addition, the first information is used to schedule the first data. Usually, a receiver of the first information and the first data feeds back, for the first data, whether the first data is correctly received, and the receiver does not feed back, for the first information, whether the first information is correctly received. However, in the foregoing technical solution, if the first information may be used to trigger AI processing (for example, the first processing and/or the second processing), the first indication information indicates whether the first information is correctly received, so that a receiver of the first indication information determines whether the first communication apparatus triggers corresponding AI processing based on the first information.

Optionally, it can be learned from the foregoing implementation process that there may be an association relationship between the first information received by the first communication apparatus based on the configuration information and the second information sent by the first communication apparatus in step S303. In addition to Implementation A and Implementation B, the association relationship may have another implementation.

For example, if the first indication information indicates that the first information is correctly received, when the first data is the data obtained through the first processing and the second data is the gradient data obtained based on the data obtained by performing the second processing based on the first data and the label data (namely, in a case of Implementation 1), the first indication information is further used to trigger the first processing.

For another example, if the first indication information indicates that the first information is correctly received, when the second data is the data obtained through the first processing and the first data is the gradient data obtained based on the data obtained by performing the second processing based on the second data and the label data (namely, in a case of Implementation 2), the first indication information is further used to trigger the second processing. Specifically, when the first indication information indicates that the first information is correctly received, the first indication information may be further used to trigger AI processing (for example, the first processing and/or the second processing).

It should be noted that, for an implementation process of triggering the first processing or the second processing based on the first indication information, refer to the foregoing process of triggering the first processing or the second processing based on the first information or the second information (for example, the implementation processes shown in FIG. 4b to FIG. 4d).

Therefore, the first indication information indicates that the first information is correctly received, so that the receiver of the first indication information can trigger corresponding AI processing based on the first indication information.

In a possible implementation, the first indication information further indicates whether to perform processing based on the first data.

Optionally, when the first data is the data obtained through the first processing and the second data is the gradient data obtained based on the data obtained by performing the second processing based on the first data and the label data (namely, in a case of Implementation 1), the first data may be data obtained based on the second data. Therefore, that the first indication information may further indicate whether to perform processing based on the first data may be understood that the first indication information may further indicate whether the first communication apparatus performs further processing based on the data obtained by performing the second processing based on the first data and the label data, to obtain the gradient data.

Optionally, when the second data is the data obtained through the first processing and the first data is the gradient data obtained based on the data obtained by performing the second processing based on the second data and the label data (namely, in a case of Implementation 2), the second data may be data obtained based on the first data. Therefore, that the first indication information may further indicate whether to perform processing based on the first data may be understood that the first indication information may further indicate whether the first communication apparatus performs gradient updating processing based on the first data (namely, the gradient data). Specifically, in addition to indicating whether the first information is correctly received, the first indication information further indicates whether to perform processing based on the first data. In this manner, the first indication information can be reused to implement more indications, to reduce overheads.

In a possible implementation, after the first communication apparatus sends the second information in step S303, the method further includes: The first communication apparatus receives second indication information. The second indication information indicates whether the second information is correctly received. Specifically, after the first communication apparatus sends the second information, the first communication apparatus may further receive the second indication information, so that the first communication apparatus determines, based on the second indication information, whether the second communication apparatus correctly receives the second information. Subsequently, the first communication apparatus may determine, based on the second indication information, whether to retransmit the second information and/or the second data scheduled based on the second information.

Optionally, it can be learned from the foregoing implementation process that there may be an association relationship between the first information received by the first communication apparatus based on the configuration information and the second information sent by the first communication apparatus in step S303. In addition to Implementation A and Implementation B, the association relationship may have another implementation.

For example, if the second indication information indicates that the second information is correctly received, when the first data is the data obtained through the first processing and the second data is the gradient data obtained based on the data obtained by performing the second processing based on the first data and the label data (namely, in a case of Implementation 1), the second indication information is further used to trigger the second processing.

For another example, if the second indication information indicates that the second information is correctly received, when the second data is the data obtained through the first processing and the first data is the gradient data obtained based on the data obtained by performing the second processing based on the second data and the label data (namely, in a case of Implementation 2), the second indication information is used to trigger the first processing.

It should be noted that, for an implementation process of triggering the first processing or the second processing based on the second indication information, refer to the foregoing process of triggering the first processing or the second processing based on the first information or the second information (for example, the implementation processes shown in FIG. 4b to FIG. 4d).

Therefore, when the second indication information indicates that the second information is correctly received, the second indication information may be further used to trigger AI processing (for example, the first processing and/or the second processing). Therefore, the second indication information indicates that the second information is correctly received, so that a receiver of the second indication information can trigger corresponding AI processing based on the second indication information.

In a possible implementation, if the first communication apparatus receives the second indication information, in addition to indicating whether the second information is correctly received, the second indication information further indicates whether to perform processing based on the second data.

In an implementation example, when the first data is the data obtained through the first processing and the second data is the gradient data obtained based on the data obtained by performing the second processing based on the first data and the label data (namely, in a case of Implementation 1), the first data may be data obtained based on the second data. Therefore, that the second indication information may further indicate whether to perform processing based on the second data may be understood that the second indication information may further indicate whether the second communication apparatus performs gradient updating processing based on the second data (namely, the gradient data).

In another implementation example, when the second data is the data obtained through the first processing and the first data is the gradient data obtained based on the data obtained by performing the second processing based on the second data and the label data (namely, in a case of Implementation 2), the second data may be data obtained based on the first data. Therefore, that the second indication information may further indicate whether to perform processing based on the second data may be understood that the second indication information may further indicate whether the second communication apparatus performs further processing based on the data obtained by performing the second processing based on the second data and the label data, to obtain the gradient data.

Therefore, in addition to indicating whether the second information is correctly received, the second indication information further indicates whether to perform processing based on the second data. In this manner, the second indication information can be reused to implement more indications, to reduce overheads.

In a possible implementation, the second information sent by the first communication apparatus in step S303 further indicates at least one of the following items: a data type of the second data, and whether to send gradient information determined based on the second data. Specifically, the second information further indicates at least one of the foregoing items, so that a receiver (namely, the second communication apparatus) of the second information can obtain, based on the second information, other information associated with the second data, and assist in subsequent processing of the second data based on the other information.

In a possible implementation, the first information configured based on the configuration information received by the first communication apparatus in step S301 further indicates at least one of the following items: a data type of the first data, and whether to send gradient information determined based on the first data. Specifically, the first information further indicates at least one of the foregoing items, so that a receiver (namely, the first communication apparatus) of the first information can obtain, based on the first information, other information associated with the first data, and assist in subsequent processing of the first data based on the other information.

In a possible implementation, after the first communication apparatus receives the first information based on the configuration information in step S301, the method further includes: When the first information is incorrectly parsed, the first communication apparatus determines not to receive the first data. Optionally, after the first communication apparatus receives the first information, the method further includes: When the first information is incorrectly parsed, the first communication apparatus does not expect to receive the first data. Specifically, when the first information is incorrectly parsed, the first communication apparatus may determine not to receive the first data, to avoid receiving incorrect data.

In a possible implementation, before step S301, the method further includes: The first communication apparatus sends capability information of the first communication apparatus. The capability information of the first communication apparatus is used to determine the configuration information. The AI capability information of the first communication apparatus includes at least one of the following items: processing delay information of the first communication apparatus for forward data in an AI network structure to which the first data belongs, processing delay information of the first communication apparatus for backward data in the AI network structure to which the first data belongs, a batch size of the first data, load information of a processing resource of the first communication apparatus, and computational power resource information of the first communication apparatus. Specifically, the first communication apparatus may send the capability information of the first communication apparatus, so that the second communication apparatus determines, based on the capability information, configuration information adapted to the capability information, and the first communication apparatus can receive a success rate of the first information based on the configuration information.

Optionally, the configuration information includes at least one of the following items: a periodicity of the first information, window duration of detecting the first information, and a position of a transmission symbol of the first information in a slot. For example, the configuration information may include the first configuration, the at least one item may be included in the first configuration, and the first configuration is used to configure the search space for the first information.

In an implementation example, an example in which the first communication apparatus is a terminal device and the second communication apparatus is a network device is used. In other words, the terminal device may receive the configuration information in step S301, and the terminal device may send the capability information before step S301. The capability information may be used to determine the configuration information. The network device may receive capability information of one or more terminal devices, and send the configuration information to each of the one or more terminal devices.

For example, the network device may store a mapping relationship between a capability of the terminal device and a resource of the first information configured based on the configuration information. As shown in Table 2, an example in which the resource of the first information configured based on the configuration information is a search space of the DCI is used.

TABLE 2

| Capability | Task identifier | | | |
|---|---|---|---|---|
| index | 0 | 1 | 2 | . . . |
| 0 | SearchSpaceId0 | SearchSpaceId1 | SearchSpaceId2 | |
| 1 | SearchSpaceId2 | SearchSpaceId3 | SearchSpaceId4 | |
| 2 | SearchSpaceId5 | SearchSpaceId6 | SearchSpaceId7 | |
| . . . | . . . | . . . | . . . | . . . |

The capability indexes may correspond to different capabilities of the terminal device. For example, different capability indexes may represent a computational power level, a computing delay, and the like of devices. The task identifier may be a task index (Task index), and may correspond to different tasks, or may correspond to different neural network structures, or may correspond to different model complexity, or the like. In addition, searchSpaceId x (in the example shown in Table 2, a value of x ranges from 0 to 7) indicates a specific searchSpace configuration, and a configuration example of searchSpace is shown in Table 3 below.

TABLE 3

| | |
|---|---|
| SearchSpace ::= | SEQUENCE { |
| searchSpaceId | SearchSpaceId, |
| controlResourceSetId | controlResourceSetId, |
| searchSpaceType | CHOICE { |
| common | SEQUENCE { |

```
    ...
  }
```

| | |
|---|---|
| ue-Specific | SEQUENCE { |

```
    ...
  }
```

| | |
|---|---|
| task-Specific | SEQUENCE { |
| dci-Formats | ENUMERATED {formats0-0-And-1-0, |

formats0-1-And-1-1, formatX-0-And-X-1},

| | |
|---|---|
| dci-FormatX-0-AndFormatX-1 | SEQUENCE{ |
| monitoringSlotPeriodicityAndOffset | CHOICE { |

| | |
|---|---|
| sl160 | INTEGER |

(0..159),
}

| | |
|---|---|
| Duration | INTEGER (2..159), |
| monitoringSymbolsWithinSlot | BIT STRING (SIZE (14)) |

```
    }
  }
  }
}
```

It should be understood that, in Table 3, the searchSpace configuration may include one or more fields in Table 3. In Table 3, some information elements are defined as follows:

The “monitoringSlotPeriodicityAndOffset” information element indicates a monitoring periodicity (namely, the periodicity of the first information), sl160 indicates 160 slots, and a value indicates an offset in the 160 slots.

The “Duration” information element indicates duration required for monitoring (namely, the window duration of detecting the first information).

The “monitoringSymbolsWithinSlot” information element indicates a start symbol in a monitoring slot (namely, a position of a transmission symbol of the first information in the slot).

Optionally, for a same terminal device, the network device may configure different searchSpace configurations based on different training tasks/neural network structures. To be specific, the configuration information received by the terminal device in step S301 may include different searchSpace configurations. The different searchSpace configurations respectively correspond to different training tasks, or the searchSpace configurations respectively correspond to different neural network structures.

In a possible implementation, the method shown in FIG. 3 may further include: The first communication apparatus receives third information. The third information indicates at least one of the following items: information about the AI network structure to which the first data belongs, a hyperparameter of the AI network structure, and dataset information of an AI task to which the first data belongs. Specifically, the first communication apparatus may further receive the third information indicating at least one of the foregoing items, so that the first communication apparatus can perform a subsequent AI processing process based on the third information (for example, when the second processing in Implementation 1 includes AI processing, or when the first processing in Implementation 2 includes AI processing).

Based on FIG. 3 and a related technical solution, the first data is the data obtained through the first processing and the second data is the gradient data obtained based on the data obtained by performing the second processing on the first data and the label data; or the second data is the data obtained through the first processing and the first data is the gradient data obtained based on the data obtained by performing the second processing on the second data and the label data. In addition, the first processing includes AI processing, and/or the second processing includes AI processing. In other words, the second data is gradient data corresponding to data obtained by performing AI processing based on the first data, or the first data is gradient data corresponding to data obtained by performing AI processing based on the second data. Therefore, when a communication apparatus in a communication system serves as an AI participating node, computational power of the communication apparatus can be applied to AI processing, and flexibility of AI deployment can be improved.

In addition, the configuration information received by the first communication apparatus in step S301 is used to configure the transmission resource of the first information, and the first information is used to schedule transmission of the first data. Correspondingly, the first communication apparatus can receive the first data based on the first information in step S302. In addition, after the first communication apparatus sends the second information used to schedule transmission of the second data in step S303, the first communication apparatus can send the second data based on the second information in step S304. In other words, when one or both of the first data and the second data are data associated with AI processing, the first communication apparatus can implement, through scheduling based on the first information and the second information, transmission of the data associated with the AI processing. Therefore, scheduling, based on the first information and the second information, the data associated with the AI processing can improve a transmission success rate of the data associated with the AI processing.

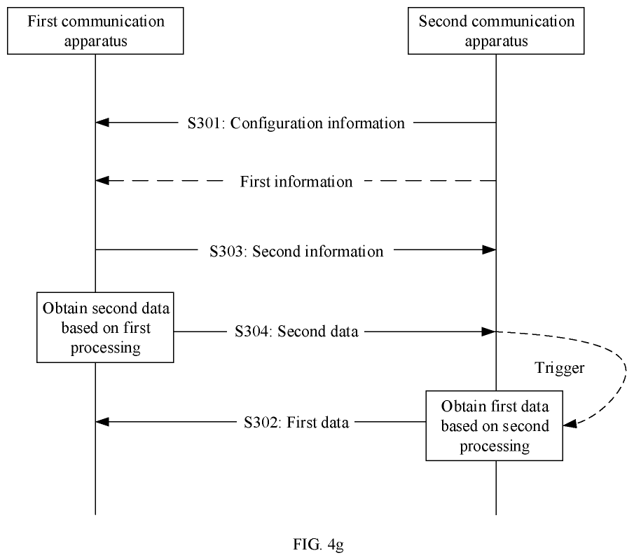

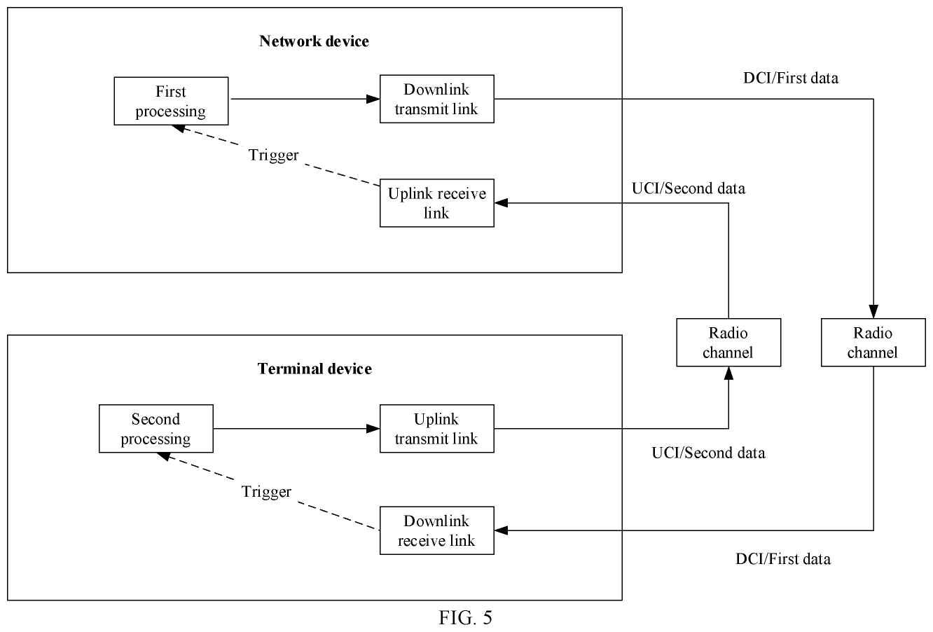

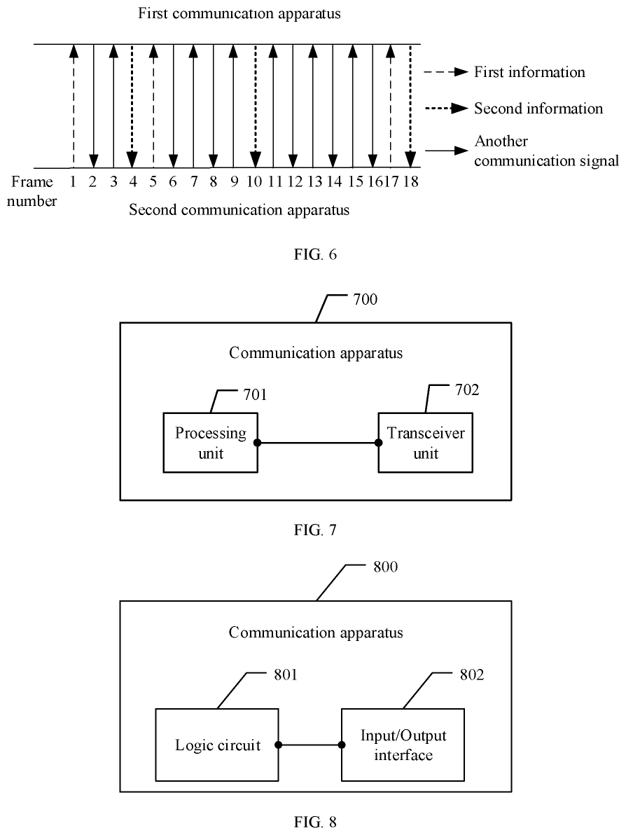

As shown in FIG. 7, an embodiment of this application provides a communication apparatus 700. The communication apparatus 700 can implement the functions of the second communication apparatus or the first communication apparatus in the foregoing method embodiments, and therefore can further implement beneficial effects of the foregoing method embodiments. In this embodiment of this application, the communication apparatus 700 may be the first communication apparatus (or the second communication apparatus), or may be an integrated circuit, an element, or the like in the first communication apparatus (or the second communication apparatus), for example, a chip.

It should be noted that a transceiver unit 702 may include a sending unit and a receiving unit, which are respectively configured to perform sending and receiving.

In a possible implementation, when the apparatus 700 is configured to perform the method performed by the first communication apparatus in the foregoing embodiments, the apparatus 700 includes a processing unit 701 and a transceiver unit 702. The transceiver unit 702 is configured to receive configuration information. The configuration information is used to configure a transmission resource of first information, and the first information is used to schedule transmission of first data. The processing unit 701 is configured to receive the first data based on the first information. The transceiver unit 702 is further configured to send second information. The second information is used to schedule transmission of second data. The processing unit 701 is further configured to send the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

In a possible implementation, when the apparatus 700 is configured to perform the method performed by the second communication apparatus in the foregoing embodiments, the apparatus 700 includes a processing unit 701 and a transceiver unit 702. The transceiver unit 702 is configured to send configuration information. The configuration information is used to configure a transmission resource of first information, and the first information is used to schedule transmission of first data. The processing unit 701 is configured to send the first data based on the first information. The transceiver unit 702 is further configured to receive second information. The second information is used to schedule transmission of second data. The processing unit 701 is further configured to receive the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

It should be noted that, for details about content such as information execution processes of the units of the communication apparatus 700, refer to the descriptions in the foregoing method embodiments of this application. Details are not described herein again.

FIG. 8 is a diagram of another structure of a communication apparatus 800 according to this application. The communication apparatus 800 includes a logic circuit 801 and an input/output interface 802. The communication apparatus 800 may be a chip or an integrated circuit.

The transceiver unit 702 shown in FIG. 7 may be a communication interface. The communication interface may be the input/output interface 802 in FIG. 8, and the input/output interface 802 may include an input interface and an output interface. Alternatively, the communication interface may be a transceiver circuit, and the transceiver circuit may include an input interface circuit and an output interface circuit.

Optionally, the input/output interface 802 is configured to receive configuration information. The configuration information is used to configure a transmission resource of first information, and the first information is used to schedule transmission of first data. The logic circuit 801 is configured to receive the first data based on the first information. The input/output interface 802 is further configured to send second information. The second information is used to schedule transmission of second data. The logic circuit 801 is further configured to send the second data based on the second information. The first data is data obtained through first processing and the second data is gradient data obtained based on data obtained by performing second processing based on the first data and label data, or the second data is data obtained through first processing and the first data is gradient data obtained based on data obtained by performing second processing based on the second data and label data. The first processing includes AI processing, and/or the second processing includes AI processing.

Optionally, the input/output interface 802 is configured to send configuration information. The configuration information is used to configure a transmission resource of first information, and the first information is used to schedule transmission of first data. The logic circuit 801 is configured to send the first data based on the first information. The input/output interface 802 is further configured to receive second information. The second information is used to schedule transmission of second data. The logic circuit 801 is further configured to receive the second data based on the second information. The first data is data obtained through first processing, and the second data is gradient data obtained based on data obtained by performing second processing on the first data and label data; or the second data is data obtained through first processing, and the first data is gradient data obtained based on data obtained by performing second processing on the second data and label data. The first processing includes AI processing, and/or the second processing includes AI processing.

The logic circuit 801 and the input/output interface 802 may further perform another step performed by the first communication apparatus or the second communication apparatus in any embodiment, and implement corresponding beneficial effects. Details are not described herein again.

In a possible implementation, the processing unit 701 shown in FIG. 7 may be the logic circuit 801 in FIG. 8.

Optionally, the logic circuit 801 may be a processing apparatus. A part or all of functions of the processing apparatus may be implemented by using software. Some or all functions of the processing apparatus may be implemented through software.

Optionally, the processing apparatus may include a memory and a processor. The memory is configured to store a computer program, and the processor reads and executes the computer program stored in the memory, to perform corresponding processing and/or steps in any method embodiment.

Optionally, the processing apparatus may include only a processor. A memory configured to store a computer program is located outside the processing apparatus, and the processor is connected to the memory through a circuit/wire, to read and execute the computer program stored in the memory. The memory and the processor may be integrated together, or may be physically independent of each other.

Optionally, the processing apparatus may be one or more chips, or one or more integrated circuits. For example, the processing apparatus may be one or more field programmable gate arrays (FPGA), an application-specific integrated chip (ASIC), a system-on-a-chip (SoC), a central processing unit (CPU), a network processor (NP), a digital signal processing circuit (digital signal processor, DSP), a microcontroller (microcontroller unit, MCU), a programmable controller (programmable logic device, PLD), or another integrated chip, or any combination of the foregoing chips or processors.

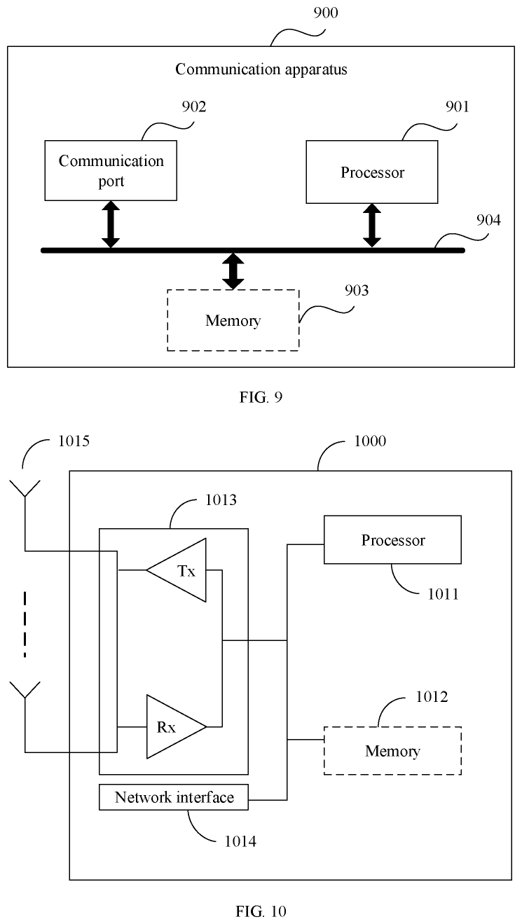

FIG. 9 shows a communication apparatus 900 in the foregoing embodiments according to an embodiment of this application. The communication apparatus 900 may be specifically a communication apparatus serving as a terminal device in the foregoing embodiments. In the example shown in FIG. 9, the terminal device is implemented by using a terminal device (or a component in the terminal device).

In a diagram of a possible logical structure of the communication apparatus 900, the communication apparatus 900 may include but is not limited to at least one processor 901 and a communication port 902.

The transceiver unit 702 shown in FIG. 7 may be a communication interface. The communication interface may be the communication port 902 in FIG. 9. The communication port 902 may include an input interface and an output interface. Alternatively, the communication port 902 may be a transceiver circuit, and the transceiver circuit may include an input interface circuit and an output interface circuit.

Further optionally, the apparatus may include at least one of a memory 903 and a bus 904. In this embodiment of this application, the at least one processor 901 is configured to control an action of the communication apparatus 900.

In addition, the processor 901 may be a central processing unit, a general-purpose processor, a digital signal processor, an application-specific integrated circuit, a field programmable gate array or another programmable logic device, a transistor logic device, a hardware component, or any combination thereof. The processor 901 may implement or execute various example logical blocks, modules, and circuits described with reference to content disclosed in this application. Alternatively, the processor may be a combination of processors implementing a computing function, for example, a combination of one or more microprocessors, or a combination of a digital signal processor and a microprocessor. It may be clearly understood by a person skilled in the art that, for the purpose of convenient and brief description, for a detailed working process of the foregoing system, apparatus, and unit, refer to a corresponding process in the foregoing method embodiments, and details are not described herein again.

It should be noted that the communication apparatus 900 shown in FIG. 9 may be specifically configured to implement the steps implemented by the terminal device in the foregoing method embodiments, and achieve the technical effects corresponding to the terminal device. For a specific implementation of the communication apparatus shown in FIG. 9, refer to the descriptions in the foregoing method embodiments. Details are not described herein again.

FIG. 10 is a diagram of a structure of a communication apparatus 1000 in the foregoing embodiment according to an embodiment of this application. The communication apparatus 1000 may be specifically the communication apparatus serving as the network device in the foregoing embodiment. In the example shown in FIG. 10, the communication apparatus 1100 is implemented as a network device (or a component in a network device). For a structure of the communication apparatus, refer to the structure shown in FIG. 10.

The communication apparatus 1000 includes at least one processor 1011 and at least one network interface 1014. Further optionally, the communication apparatus includes at least one memory 1012, at least one transceiver 1013, and one or more antennas 1015. The processor 1011, the memory 1012, the transceiver 1013, and the network interface 1014 are connected, for example, connected through a bus. In this embodiment of this application, the connection may include various interfaces, transmission lines, buses, or the like. This is not limited in this embodiment. The antenna 1015 is connected to the transceiver 1013. The network interface 1014 is configured to enable the communication apparatus to communicate with another communication device through a communication link. For example, the network interface 1014 may include a network interface between the communication apparatus and a core network device, for example, an S1 interface. The network interface may include a network interface between the communication apparatus and another communication apparatus (for example, another network device or core network device), for example, an X2 or Xn interface.

The transceiver unit 702 shown in FIG. 7 may be a communication interface. The communication interface may be the network interface 1014 in FIG. 10. The network interface 1014 may include an input interface and an output interface. Alternatively, the network interface 1014 may be a transceiver circuit, and the transceiver circuit may include an input interface circuit and an output interface circuit.

The processor 1011 is mainly configured to: process a communication protocol and communication data; and control the entire communication apparatus, execute a software program, and process data of the software program, for example, is configured to support the communication apparatus in performing actions described in embodiments. The communication apparatus may include a baseband processor and a central processing unit. The baseband processor is mainly configured to process the communication protocol and the communication data. The central processing unit is mainly configured to control an entire terminal device, execute the software program, and process the data of the software program. Functions of the baseband processor and the central processing unit may be integrated into the processor 1011 in FIG. 10. A person skilled in the art can understand that the baseband processor and the central processing unit may alternatively be processors independent of each other, and are interconnected through a technology like a bus. A person skilled in the art may understand that the terminal device may include a plurality of baseband processors to adapt to different network standards, and the terminal device may include a plurality of central processing units to enhance processing capabilities of the terminal device, and components of the terminal device may be connected by using various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of a software program, and the processor executes the software program to implement a baseband processing function.

The memory is mainly configured to store the software program and data. The memory 1012 may exist independently, and is connected to the processor 1011. Optionally, the memory 1012 and the processor 1011 may be integrated together, for example, integrated into one chip. The memory 1012 can store program code for performing the technical solutions in embodiments of this application, and execution of the program code is controlled by the processor 1011. Various types of executed computer program code may also be considered as a driver of the processor 1011.

FIG. 10 shows only one memory and one processor. In an actual terminal device, there may be a plurality of processors and a plurality of memories. The memory may also be referred to as a storage medium, a storage device, or the like. The memory may be a storage element on a same chip as the processor, that is, an on-chip storage element, or may be an independent storage element. This is not limited in this embodiment of this application.

The transceiver 1013 may be configured to support receiving or sending of a radio frequency signal between the communication apparatus and a terminal. The transceiver 1013 may be connected to the antenna 1015. The transceiver 1013 includes a transmitter Tx and a receiver Rx. Specifically, the one or more antennas 1015 may receive a radio frequency signal. The receiver Rx of the transceiver 1013 is configured to receive the radio frequency signal from the antenna, convert the radio frequency signal into a digital baseband signal or a digital intermediate frequency signal, and provide the digital baseband signal or the digital intermediate frequency signal for the processor 1011, so that the processor 1011 further processes the digital baseband signal or the digital intermediate frequency signal, for example, performs demodulation and decoding. In addition, the transmitter Tx of the transceiver 1013 is further configured to receive a modulated digital baseband signal or digital intermediate frequency signal from the processor 1011, convert the modulated digital baseband signal or digital intermediate frequency signal into a radio frequency signal, and send the radio frequency signal through the one or more antennas 1015. Specifically, the receiver Rx may selectively perform one-level or multi-level down frequency mixing and analog-to-digital conversion on the radio frequency signal to obtain the digital baseband signal or the digital intermediate frequency signal. An order of the down frequency mixing and the analog-to-digital conversion is adjustable. The transmitter Tx may selectively perform one-level or multi-level up frequency mixing and digital-to-analog conversion on the modulated digital baseband signal or digital intermediate frequency signal to obtain the radio frequency signal. An order of the up frequency mixing and the digital-to-analog conversion is adjustable. The digital baseband signal and the digital intermediate frequency signal may be collectively referred to as a digital signal.

The transceiver 1013 may also be referred to as a transceiver unit, a transceiver device, a transceiver apparatus, or the like. Optionally, a component that is in the transceiver unit and that is configured to implement a receiving function may be considered as a receiving unit, and a component that is in the transceiver unit and that is configured to implement a sending function may be considered as a sending unit. That is, the transceiver unit includes the receiving unit and the sending unit. The receiving unit may also be referred to as a receiver, an input interface, a receiver circuit, or the like. The sending unit may be referred to as a transmitting device, a transmitter, a transmitter circuit, or the like.

It should be noted that, the communication apparatus 1000 shown in FIG. 10 may be specifically configured to implement steps implemented by the network device in the foregoing method embodiments, and achieve technical effects corresponding to the network device. For a specific implementation of the communication apparatus 1000 shown in FIG. 10, refer to the descriptions in the foregoing method embodiments. Details are not described herein again.

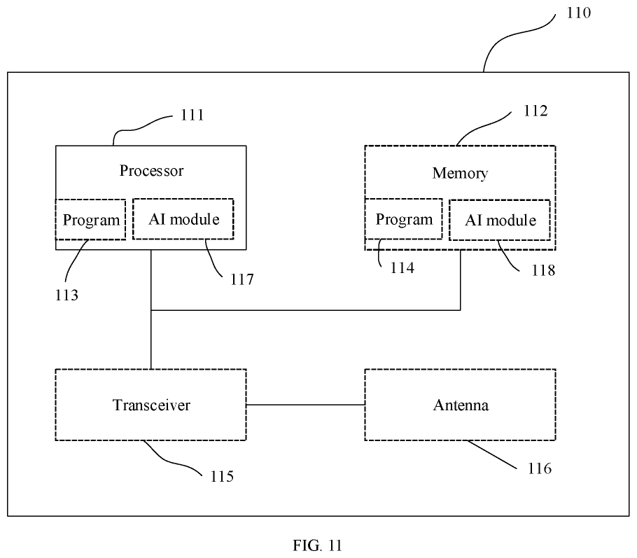

FIG. 11 is a diagram of a structure of a communication apparatus in the foregoing embodiment according to an embodiment of this application.

It may be understood that a communication apparatus 110 includes, for example, modules, units, elements, circuits, or interfaces, which are appropriately configured together to perform the technical solutions provided in this application. The communication apparatus 110 may be the terminal device or the network device described above, or may be a component (for example, a chip) in these devices, to implement the method described in the following method embodiments. The communication apparatus 110 includes one or more processors 111. The processor 111 may be a general-purpose processor, a dedicated processor, or the like. For example, the processor may be a baseband processor or a central processing unit. The baseband processor may be configured to process a communication protocol and communication data. The central processing unit may be configured to: control the communication apparatus (for example, the RAN node, the terminal, or the chip), execute a software program, and process data of the software program.

Optionally, in a design, the processor 111 may include a program 113 (which may also be referred to as code or instructions sometimes). The program 113 may be run on the processor 111, so that the communication apparatus 110 performs the method described in the foregoing embodiments. In another possible design, the communication apparatus 110 includes a circuit (not shown in FIG. 11).

Optionally, the communication apparatus 110 may include one or more memories 112 storing a program 114 (which may also be referred to as code or instructions sometimes). The program 114 may be run on the processor 111, so that the communication apparatus 110 performs the method described in the foregoing method embodiments.

Optionally, the processor 111 and/or the memory 112 may include AI modules 117 and 118, and the AI module is configured to implement an AI-related function. The AI module may be implemented by using software, hardware, or a combination of software and hardware. For example, the AI module may include a radio intelligence control (RIC) module. For example, the AI module may be a near-real-time RIC or a non-real-time RIC.

Optionally, the processor 111 and/or the memory 112 may further store data. The processor and the memory may be separately disposed, or may be integrated together.

Optionally, the communication apparatus 110 may further include a transceiver 115 and/or an antenna 116. The processor 111 may also be referred to as a processing unit sometimes, and controls the communication apparatus (for example, the RAN node or the terminal). The transceiver 115 may also be referred to as a transceiver unit, a transceiver machine, a transceiver circuit, a transceiver, or the like sometimes, and is configured to implement a transceiver function of the communication apparatus through the antenna 116.

The processing unit 701 in FIG. 7 may be the processor 111. The transceiver unit 702 shown in FIG. 7 may be a communication interface. The communication interface may be the transceiver 115 in FIG. 11. The transceiver 115 may include an input interface and an output interface. Alternatively, the transceiver 115 may be a transceiver circuit, and the transceiver circuit may include an input interface circuit and an output interface circuit.

An embodiment of this application further provides a computer-readable storage medium. The storage medium is configured to store one or more computer-executable instructions. When the computer-executable instructions are executed by a processor, the processor performs the method in the possible implementations of the first communication apparatus or the second communication apparatus in the foregoing embodiments.

An embodiment of this application further provides a computer program product (also referred to as a computer program). When the computer program product is executed by a processor, the processor performs the method in the possible implementations of the first communication apparatus or the second communication apparatus.

An embodiment of this application further provides a chip system. The chip system includes at least one processor, configured to support a communication apparatus in implementing the functions in the foregoing possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be specifically the first communication apparatus or the second communication apparatus in the foregoing method embodiments.

An embodiment of this application further provides a communication system. An architecture of the communication system includes the first communication apparatus and the second communication apparatus in any one of the foregoing embodiments.

In the several embodiments provided in this application, it should be understood that the disclosed system, apparatus, and method may be implemented in other manners. For example, the described apparatus embodiment is merely an example. For example, division into the units is merely logical functional division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units may be integrated into one unit. The integrated unit may be implemented in a form of hardware, or may be implemented in a form of a software functional unit. When the integrated unit is implemented in the form of the software functional unit and sold or used as an independent product, the integrated unit may be stored in a computer-readable storage medium. Based on such an understanding, the technical solutions of this application essentially, or the part making a contribution, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in embodiments of this application. The storage medium includes any medium that can store program code, such as a USB flash drive, a removable hard disk, a read-only memory (ROM), a random access memory (RAM), a magnetic disk, or an optical disc.

1.-20. (canceled)

21. A communication method, comprising:
receiving configuration information, wherein the configuration information is used to configure a transmission resource of first information, and the first information is used to schedule transmission of first data;
receiving the first data based on the first information;
sending second information, wherein the second information is used to schedule transmission of second data; and
sending the second data based on the second information,
wherein:
the first data is data obtained through first processing and the second data is gradient data obtained based on label data and data obtained by performing second processing based on the first data, or
the second data is data obtained through the first processing and the first data is gradient data obtained based on the label data and data obtained by performing the second processing based on the second data, and
wherein at least one of: the first processing comprises artificial intelligence (AI) processing, or the second processing comprises AI processing.

22. The method according to claim 21, wherein the transmission resource of the first information comprises a time domain resource carrying the first information; and
a time interval between the time domain resource carrying the first information and a time domain resource carrying the second information is preconfigured.

23. The method according to claim 21, wherein the first data is the data obtained through the first processing and the second data is the gradient data obtained based on the label data and the data obtained by performing the second processing based on the first data;
the first processing satisfies any one of the following: the first processing is triggered based on the second information, or the first information is triggered based on the first processing; and
the second processing satisfies any one of the following: the second processing is triggered based on the first information, the second information is triggered based on the second processing, the second processing is triggered based on the first data, or the second processing is triggered based on the first information and the first data.

24. The method according to claim 21, wherein the second data is the data obtained through the first processing and the first data is the gradient data obtained based on the label data and the data obtained by performing the second processing based on the second data;
the first processing satisfies any one of the following: the first processing is triggered based on the first information, or the second information is triggered based on the first processing; and
the second processing satisfies any one of the following: the second processing is triggered based on the second information, the first information is triggered based on the second processing, the second processing is triggered based on the second data, or the second processing is triggered based on the second information and the second data.

25. The method according to claim 23, wherein the configuration information comprises a first configuration and a second configuration, the first configuration is used to configure a search space of the first information, and the second configuration is used to configure a retransmission timer of the second information; and
a time length of a periodicity corresponding to the search space is less than or equal to a time length of the retransmission timer.

26. The method according to claim 21, further comprising:
sending first indication information, wherein the first indication information indicates whether the first information is correctly received.

27. The method according to claim 26, wherein
the first indication information indicates that the first information is correctly received;
when the first data is the data obtained through the first processing, and the second data is the gradient data obtained based on the label data and the data obtained by performing the second processing based on the first data, the first indication information is further used to trigger the first processing; and
when the second data is the data obtained through the first processing, and the first data is the gradient data obtained based on the label data and the data obtained by performing the second processing based on the second data, the first indication information is further used to trigger the second processing.

28. A communication method, comprising:
sending configuration information, wherein the configuration information is used to configure a transmission resource of first information, and the first information is used to schedule transmission of first data;
sending the first data based on the first information;
receiving second information, wherein the second information is used to schedule transmission of second data; and
receiving the second data based on the second information,
wherein:
the first data is data obtained through first processing and the second data is gradient data obtained based on label data and data obtained by performing second processing based on the first data, or
the second data is data obtained through the first processing and the first data is gradient data obtained based on the label data and data obtained by performing the second processing based on the second data, and
wherein at least one of: the first processing comprises artificial intelligence (AI) processing, or the second processing comprises AI processing.

29. The method according to claim 28, wherein the transmission resource of the first information comprises a time domain resource carrying the first information; and
a time interval between the time domain resource carrying the first information and a time domain resource carrying the second information is preconfigured.

30. The method according to claim 28, wherein the first data is the data obtained through the first processing and the second data is the gradient data obtained based on the label data and the data obtained by performing the second processing based on the first data;
the first processing satisfies any one of the following: the first processing is triggered based on the second information, or the first information is triggered based on the first processing; and
the second processing satisfies any one of the following: the second processing is triggered based on the first information, the second information is triggered based on the second processing, the second processing is triggered based on the first data, or the second processing is triggered based on the first information and the first data.

31. The method according to claim 28, wherein the second data is the data obtained through the first processing and the first data is the gradient data obtained based on the label data and the data obtained by performing the second processing based on the second data;
the first processing satisfies any one of the following: the first processing is triggered based on the first information, or the second information is triggered based on the first processing; and
the second processing satisfies any one of the following: the second processing is triggered based on the second information, the first information is triggered based on the second processing, the second processing is triggered based on the second data, or the second processing is triggered based on the second information and the second data.

32. The method according to claim 30, wherein the configuration information comprises a first configuration and a second configuration, the first configuration is used to configure a search space of the first information, and the second configuration is used to configure a retransmission timer of the second information; and
a time length of a periodicity corresponding to the search space is less than or equal to a time length of the retransmission timer.

33. The method according to claim 28, further comprising:
receiving first indication information, wherein the first indication information indicates whether the first information is correctly received.

34. A communication apparatus, comprising:
at least one processor; and
one or more non-transitory memories coupled to the at least one processor and storing programming instructions for execution by the at least one processor, the instructions when executed enable the communication apparatus to:
receive configuration information, wherein the configuration information is used to configure a transmission resource of first information, and the first information is used to schedule transmission of first data;
receive the first data based on the first information;
send second information, wherein the second information is used to schedule transmission of second data; and
send the second data based on the second information,
wherein:
the first data is data obtained through first processing and the second data is gradient data obtained based on label data and data obtained by performing second processing based on the first data, or
the second data is data obtained through first processing and the first data is gradient data obtained based on the label data and data obtained by performing the second processing based on the second data, and
wherein at least one of: the first processing comprises artificial intelligence (AI) processing, or the second processing comprises AI processing.

35. The communication apparatus according to claim 34, wherein the transmission resource of the first information comprises a time domain resource carrying the first information; and
a time interval between the time domain resource carrying the first information and a time domain resource carrying the second information is preconfigured.

36. The communication apparatus according to claim 34, wherein the first data is the data obtained through the first processing and the second data is the gradient data obtained based on the label data and the data obtained by performing the second processing based on the first data;
the first processing satisfies any one of the following: the first processing is triggered based on the second information, or the first information is triggered based on the first processing; and
the second processing satisfies any one of the following: the second processing is triggered based on the first information, the second information is triggered based on the second processing, the second processing is triggered based on the first data, or the second processing is triggered based on the first information and the first data.

37. The communication apparatus according to claim 34, wherein the second data is the data obtained through the first processing and the first data is the gradient data obtained based on the label data and the data obtained by performing the second processing based on the second data;
the first processing satisfies any one of the following: the first processing is triggered based on the first information, or the second information is triggered based on the first processing; and
the second processing satisfies any one of the following: the second processing is triggered based on the second information, the first information is triggered based on the second processing, the second processing is triggered based on the second data, or the second processing is triggered based on the second information and the second data.

38. The communication apparatus according to claim 36, wherein the configuration information comprises a first configuration and a second configuration, the first configuration is used to configure a search space of the first information, and the second configuration is used to configure a retransmission timer of the second information; and
a time length of a periodicity corresponding to the search space is less than or equal to a time length of the retransmission timer.

39. The communication apparatus according to claim 34, wherein the instructions when executed further enable the communication apparatus to:
send first indication information, wherein the first indication information indicates whether the first information is correctly received.

40. The communication apparatus according to claim 39, wherein
the first indication information indicates that the first information is correctly received;
when the first data is the data obtained through the first processing and the second data is the gradient data obtained based on the label data and the data obtained by performing the second processing based on the first data, the first indication information is further used to trigger the first processing; and
when the second data is the data obtained through the first processing and the first data is the gradient data obtained based on the label data and the data obtained by performing the second processing based on the second data, the first indication information is further used to trigger the second processing.
